(19) United States
(12) Patent Application Publication
(10) Pub. No.: US 2026/0209086 A1
(43) Pub. Date: Jul. 23, 2026

(54) POLYMER IMPREGNATED AMPHOTERIC SORBENT BASED ADSORPTIVE DESALINATION AND DISINFECTION SYSTEMS, COMPONENTS, AND METHODS

(71) Applicant: University of North Carolina at Greensboro, Greensboro, NC (US)

(72) Inventor: Hemali Rathnayake, Summerfield, NC (US)

(21) Appl. No.: 19/578,121

(22) Filed: Mar. 25, 2026

Related U.S. Application Data
(63) Continuation of application No. PCT/US24/48929, filed on Sep. 27, 2024.
(60) Provisional application No. 63/541,561, filed on Sep. 29, 2023.

(51) Int. Cl. C02F 1/42; B01J 43/00; B01J 49/50; C02F 1/00; C02F 101/10; C02F 101/20; C02F 103/06; C02F 103/08

(52) U.S. Cl. CPC C02F 1/42; B01J 43/00; B01J 49/50; C02F 1/004; C02F 2001/007; C02F 2001/422; C02F 2001/425; C02F 2101/10; C02F 2101/20; C02F 2103/06; C02F 2103/08; C02F 2201/006; C02F 2303/04; C02F 2303/14; C02F 2303/16

(57) ABSTRACT

An adsorptive desalination and disinfection method for salt water includes providing a volume of salt water to be desalinated and disinfected; passing the volume through a first filter cartridge assembly configured to disinfect and remove cations from the volume, wherein the first filter cartridge assembly comprises an anionic sorbent comprising the polymer impregnated iron (III)-tannate amphoteric sorbent configured to exhibit anionic behavior, and passing the volume through a second filter cartridge assembly configured to disinfect and remove anions from the volume, wherein the second filter cartridge assembly comprises a cationic sorbent comprising the polymer impregnated iron (III)-tannate amphoteric sorbent configured to exhibit cationic behavior. The volume has particulate removed through settling and filtering prior to passing through the filter cartridges in embodiments. The method also includes passing the volume through a third filter cartridge assembly configured to remove any additional trace metal ions and further disinfect the volume.

### CROSS-REFERENCE TO RELATED APPLICATIONS

This application is a continuation of PCT Patent Application No. PCT/US2024/048929 filed on Sep. 27, 2024 and titled “POLYMER IMPREGNATED AMPHOTERIC SORBENT BASED ADSORPTIVE DESALINATION AND DISINFECTION SYSTEMS, COMPONENTS, AND METHODS”, which claims priority to the U.S. Provisional Patent Application No. 63/541,561 filed on Sep. 29, 2023 and titled “POLYMER IMPREGNATED AMPHOTERIC SORBENT BASED ADSORPTIVE DESALINATION AND DISINFECTION SYSTEMS, COMPONENTS, AND METHODS”, the entire contents of all of which are incorporated by reference herein.

### TECHNICAL FIELD

The present disclosure relates generally to the field of adsorptive desalination and disinfection systems, methods, and components, and particularly, to systems methods and components of desalination and disinfection systems utilizing a polymer impregnated amphoteric sorbent, such as a polymer impregnated iron (III)-tannate sorbent.

### BACKGROUND

Clean water is vital to any society. Indeed, every person requires a minimum amount of clean water to maintain their health. Moreover, clean water is required in numerous industries to support modern society. In fact, food, clothes, mobile phones, cars, and books all use water in their production which must meet certain requirements regarding cleanliness and salinity. Indeed, the United States' agricultural sector accounts for about 42% of total freshwater withdrawals. Globally, agriculture consumes more than 85% of available freshwater. Historically, humans have taken advantage of the water cycle to provide clean water. However, climate change, population growth, declining water quality, and industrial competition are quickly demonstrating that the requirement for clean water is outpacing our ability to rely solely on the water cycle. Moreover, only three percent of Earth's total water is considered freshwater, water having low salinity, and an even smaller proportion of that can be considered clean water, such as drinking water. Therefore, the vast majority of water on earth is saltwater and lacks the cleanliness necessary to support modern society.

Consequently, the desire to make drinkable, potable water out of seawater has existed for a long time and is on the rise. Effective desalination serves to increase the water supply far beyond what is currently available. Several customary methods exist for desalination to remove the salt and other chemicals. Indeed, existing desalination methods are broadly categorized as thermal or membrane technologies. Moreover, the effectiveness of these methods often depends on the salinity and chemistry of the water, size of the plant, and desalination objectives.

The oldest method, thermal distillation, has been around for thousands of years and is suitable for seawater. In thermal distillation, the water is boiled and then the steam is collected, leaving the salt behind. However, the vaporization phase change requires significant amounts of energy.

Membrane processes, however, are preferred for the treatment of lower-salinity, brackish, water, especially in areas where energy costs are of substantial concern. Membrane processes used for brackish water treatment are classified as pressure-driven processes, e.g., reverse osmosis (RO) and nanofiltration (NF), and electro-driven processes, e.g., electrodialysis (ED) and (membrane) capacitive deionization (CDI). In electro-driven processes, typically, electric current will be used to drive ions across a selectively permeable membrane, carrying the dissociated salt ions with it. A key characteristic of this method is that the energy requirement depends on how much salt is initially present in the water. In pressure-driven processes, typically, pressure is used to drive water through a selectively permeable membrane, leaving the salt behind. Similar to electrically-driven separation, the amount of energy required for desalination often depends on the initial salt content of the water. Despite advancements in each of these desalination techniques, substantial energy demands persist, and supplementary treatment methods are required to eliminate microbial contaminants. Moreover, membrane fouling and scaling pose significant challenges, leading to further decreased freshwater production and increased energy consumption.

In contrast, adsorption desalination systems offer a more sustainable and environmentally friendly alternative to customary methods, resulting in reduced electricity consumption and greenhouse gas emissions. Indeed, such methods can utilize almost one-third of the consumption of the customary methods and operate at low temperature conditions that can, in instances, be driven using solar energy and waste heat. Adsorption desalination is a phase transfer process that occurs at the interface between a solid and an aqueous phase where salt ions (the adsorbate) adsorb on the surface of porous solids (the adsorbent) via physical interactions (such as van der Waals interaction and hydrogen bonding) and/or chemical bonding. Adsorption can be reversed, i.e., desorption, especially physical adsorption, to regenerate the adsorbent and allow for its reuse which is key for the development of practical processes. Moreover, adsorption desalination systems can effectively desalinate high-salinity brine to produce high-quality potable water, making them an ideal candidate for integration with conventional RO systems to address the problem of brine disposal and reduce specific energy consumption.

However, adsorption desalination, along with customary desalination methods, are also limited in their ability to remove microbial contaminants. Similarly, disinfection techniques, such as chlorination, UV treatment and ozone treatment, can remove microorganisms but do not reduce the salinity of water. Accordingly, each desalination process also generally requires a disinfection process to ensure water is sufficiently clean. However, some disinfection techniques, such as chlorination, can result in the formation of undesirable byproducts.

Accordingly, there exists a need for a dual-functional process for desalination and disinfection. A dual-functional process provides an innovative, simpler, more cost-effective, less energy intensive, environmentally benign and sustainable method for saltwater treatment than current adsorption desalination or customary methods followed by chemical and UV-treatment for disinfection. Moreover, a dual-functional process also unlocks the practical potential of brackish water and industrial outputs, such as agricultural drainage, to effectively recycle water for those industries, fortifying water sources. Further, there exists a need for a dual-functional process that utilizes bio-based sorbents possessing exceptional amphoteric surface properties surpassing synthetic counterparts, like metal oxides, organic-inorganic composites, and clay-based and biomass-based sorbents, and which mitigates some of the issues of fouling and scaling inherent to certain customary methods.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

In aspects, the disclosed concerns a dual-functional method for desalination and disinfection that is simple, cost-effective, environmentally benign and sustainable, and utilizes less energy than current methods. In particular aspects, the disclosed utilizes a bio-based amphoteric sorbent in a method that is useful for the reuse of brackish water, industrial outputs, and agricultural drainage, that mitigates some of the issues of fouling and scaling.

According to at least one embodiment, an adsorptive desalination and disinfection method for saltwater utilizing a polymer impregnated amphoteric sorbent includes providing a volume of saltwater to be desalinated and disinfected, passing the volume through a first filter cartridge assembly configured to disinfect and remove cations from the volume passed therethrough, wherein the first filter cartridge assembly comprises an anionic sorbent comprising the polymer impregnated iron (III)-tannate amphoteric sorbent configured to exhibit anionic behavior. In embodiments, the method further includes passing the volume through a second filter cartridge assembly configured to disinfect and remove anions from the volume passed therethrough, wherein the second filter cartridge assembly comprises a cationic sorbent comprising the polymer impregnated iron (III)-tannate amphoteric sorbent configured to exhibit cationic behavior. According to embodiments, the volume passed through the first filter cartridge assembly and second filter cartridge assembly is at least partially desalinated and disinfected.

In embodiments, providing a volume of saltwater includes settling an input in at least one of a basin and a clarifier to produce the volume, wherein the input comprises saltwater and particulate and the basin and clarifier are each configured to remove particulate from the input. In additional embodiments, providing a volume of saltwater comprises filtering the input through a particulate filter to remove particulate therefrom and produce the volume, alone or in conjunction with settling the input, wherein the particulate filter is configured to remove particulate from the input.

In further embodiments, the adsorptive desalination and disinfection method further includes passing the volume through a third filter cartridge assembly after passing the volume through the first and second filter cartridge assemblies, wherein the third filter cartridge assembly is configured to remove trace metal ions and further disinfect the volume such that the volume comprises desalinated and disinfected water.

In certain embodiments, the adsorptive desalination and disinfection method further includes conditioning the polymer impregnated iron (III)-tannate amphoteric sorbent with ethylene glycol to produce the anionic sorbent. In particular embodiments, conditioning the polymer impregnated iron (III)-tannate amphoteric sorbent with ethylene glycol to produce the anionic sorbent includes exposing the polymer impregnated iron (III)-tannate amphoteric sorbent to an environment having a pH above 7.0. In further embodiments, conditioning the polymer impregnated iron (III)-tannate amphoteric sorbent with ethylene glycol to produce the anionic sorbent includes soaking the polymer impregnated iron (III)-tannate amphoteric sorbent in a 1:1 w/v ratio of the polymer impregnated iron (III)-tannate amphoteric sorbent to ethylene glycol. In at least one embodiment, conditioning the polymer impregnated iron (III)-tannate amphoteric sorbent with ethylene glycol to produce the anionic sorbent further includes soaking the polymer impregnated iron (III)-tannate amphoteric sorbent for 24 hours and air drying the polymer impregnated iron (III)-tannate amphoteric sorbent at ambient conditions for a plurality of hours.

In embodiments, the adsorptive desalination and disinfection method further includes conditioning the polymer impregnated iron (III)-tannate amphoteric sorbent with vinegar to produce the cationic sorbent. In particular embodiments, conditioning the polymer impregnated iron (III)-tannate amphoteric sorbent with vinegar to produce the cationic sorbent comprises exposing the polymer impregnated iron (III)-tannate amphoteric sorbent to an environment having a pH below 3.5. In further embodiments, conditioning the polymer impregnated iron (III)-tannate amphoteric sorbent with vinegar to produce the cationic sorbent comprises soaking the polymer impregnated iron (III)-tannate amphoteric sorbent in a 1:1 w/v ratio of the polymer impregnated iron (III)-tannate amphoteric sorbent to vinegar. In at least one embodiment, conditioning the polymer impregnated iron (III)-tannate amphoteric sorbent with vinegar to produce the cationic sorbent comprises soaking the polymer impregnated iron (III)-tannate amphoteric sorbent for 24 hours and air drying the polymer impregnated iron (III)-tannate amphoteric at ambient conditions for a plurality of hours.

In further embodiments, the adsorptive desalination and disinfection method further includes regenerating at least one of the anionic sorbent and cationic sorbent through soaking a respective sorbent in a first solution for 24 hours, wherein the first solution comprises 1:1 w/v ratio of the respective amphoteric sorbent to vinegar, washing the respective amphoteric sorbent in a second solution, wherein the second solution comprises 1:1 w/v ratio of the respective amphoteric sorbent to water, and air drying the respective amphoteric sorbent thereof at ambient conditions.

In certain embodiments, the first filter cartridge assembly and the second filter cartridge assembly each comprise a filter housing enclosing a removable filter cartridge comprising a respective amphoteric sorbent therein. In particular embodiments, the filter housing comprises a central cover disposed between an inlet end cap and a retentate end cap, wherein the filter cartridge is disposed within the central cover between the inlet end cap and the retentate end cap and is in fluid communication with fluid moving from the inlet end cap to the retentate end cap, and wherein at least one of the inlet end cap and retentate end cap are removable from the central cover or the central cover is configured to open to allow the filter cartridge to be removed.

In additional embodiments, the cations removed comprise at least one of sodium atom cations, potassium atom cations, magnesium atom cations, silver atom cations, cadmium atom cations, lead atom cations and calcium atom cations.

In further embodiments, the adsorptive desalination and disinfection method further includes providing the polymer impregnated amphoteric sorbent by forming a combined solution comprising an iron (III)-tannate powder and a polysulfone polymer solution, wherein the polysulfone polymer solution comprises a mixture of polysulfone and 1-methyl-2-pyrrolidone (NMP), pumping the combined solution into a volume of water to precipitate the polymer impregnated iron (III)-tannate amphoteric sorbent, removing the polymer impregnated iron (III)-tannate amphoteric sorbent from the volume of water, and drying the polymer impregnated iron (III)-tannate amphoteric sorbent.

In at least one aspect, a polymer impregnated amphoteric sorbent production method includes forming a combined solution, wherein the combined solution comprises a 1:6.5 weight ratio mixture of an iron (III)-tannate powder to a polysulfone polymer solution, and wherein the polysulfone polymer solution comprises a 1:5.5 weight ratio mixture of polysulfone to 1-methyl-2-pyrrolidone (NMP). The polymer impregnated amphoteric sorbent production method further includes pumping the combined solution into a volume of water to precipitate solids comprising polymer impregnated iron (III)-tannate amphoteric sorbent, removing the solids from the volume of water, and drying the solids.

In at least one aspect, the volume of water comprises approximately 20 milliliters for every 7.5 grams of combined solution. In another aspect, forming a combined solution includes mixing approximately 1 gram of the iron (III)-tannate powder into a solution of between 6.0 and 7.0 milliliters of the polysulfone polymer solution.

Further, the water utilized in the production method is deionized in aspects.

Moreover, the combined solution is pumped into the volume of water through a needle tip, in certain aspects. Indeed, the needle tip is 18 gauge, in particular aspects. In further aspects, the needle tip is disposed at a distance above the surface of the volume of water. Indeed, the distance between the needle tip and the surface of the volume of water is approximately 4 centimeters in at least one aspect.

In particular aspects, the combined solution is pumped into the volume of water at a rate of 0.2 milliliters per minute.

In further aspects, the solids are characterized by a generally spherical shape.

In more aspects, the production method further includes storing the solids in the volume of water for several hours prior to removing the solids from the volume of water.

In certain aspects, drying the solids comprises exposing the solids to a gas at 80 degrees Celsius for a plurality of hours.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 is a schematic of an example of an adsorption desalination system according to current understandings;

FIG. 2 is a schematic flowchart of an example of utilization of an adsorptive desalination and disinfection system and method for brackish water utilizing a polymer impregnated amphoteric sorbent according to one or more embodiments herein;

FIG. 3A is a flowchart of an adsorptive desalination and disinfection system and method for saltwater utilizing a polymer impregnated amphoteric sorbent according to one or more embodiments herein wherein input water is initially settled to remove particulate and having three filter cartridge assemblies to produce clean water;

FIG. 3B is a side elevation cross-sectional view of a settling basin utilized in settling to allow particulate to be removed from saltwater before an adsorptive desalination and disinfection system and method according to one or more embodiments herein;

FIG. 3C is a side elevation cross-sectional view of a clarifier utilized in settling to allow particulate to be removed from saltwater before an adsorptive desalination and disinfection system and method according to one or more embodiments herein;

FIG. 4 is a flowchart of an adsorptive desalination and disinfection system and method for saltwater utilizing a polymer impregnated amphoteric sorbent according to one or more embodiments herein wherein input water is initially filtered through a particulate filter to remove particulate and having two filter cartridge assemblies to produce clean water;

FIG. 5A is a flow chart of an anionic conditioning process to condition an amphoteric sorbent into an anionic sorbent to be utilized in an adsorptive desalination and disinfection system and method according to one or more embodiments herein;

FIG. 5B is a flow chart of an cationic conditioning process to condition an amphoteric sorbent into a cationic sorbent to be utilized in an adsorptive desalination and disinfection system and method according to one or more embodiments herein;

FIG. 6 is a flowchart showing that an iron (III)-tannate amphoteric sorbent can be activated to either an anionic sorbent or cationic sorbent according to one or more embodiments herein;

FIG. 7 is a flow chart of a regenerating process to recondition used anionic or cationic sorbent into amphoteric sorbent that can be reutilized in an adsorptive desalination and disinfection system and method according to one or more embodiments herein;

FIG. 8A is a side elevation view of a filter cartridge assembly that utilizes a portable filter cartridge configured to house polymer impregnated sorbents according to one or more embodiments herein and can be utilized in an adsorptive desalination system and process according to one or more embodiments herein;

FIG. 8B is a side elevation view of a filter cartridge that can house an amphoteric sorbent and be utilized in a filter cartridge assembly reutilized in an adsorptive desalination and disinfection system and method according to one or more embodiments herein;

FIG. 9 is a flowchart of a polymer impregnation process whereby an amphoteric sorbent, such as iron (III)-tannate, can be impregnated and form spherical solids useful for utilization in a filter cartridge utilized in an adsorptive desalination and disinfection system and method according to one or more embodiments herein;

FIG. 10A shows two graphical representations of removal of sodium (Na⁺) and calcium (Ca⁺) from an experiment utilizing an adsorptive desalination and disinfection system and method according to one or more embodiments herein;

FIG. 10B shows two graphical representations of removal of magnesium (Mg⁺²) and potassium (K⁺) from an experiment utilizing an adsorptive desalination and disinfection system and method according to one or more embodiments herein;

FIG. 11A shows three graphical representations of adsorption capacity for sorbent for silver (Ag⁺), cadmium (Cd⁺²) and lead (Pb⁺²) ions with respect to concentration from an experiment utilizing an adsorptive desalination and disinfection system and method according to one or more embodiments herein;

FIG. 11B shows three graphical representations of adsorption capacity for sorbent for silver (Ag⁺), cadmium (Cd⁺²) and lead (Pb⁺²) ions with respect to time with a fixed 500 ppm concentration from an experiment utilizing an adsorptive desalination and disinfection system and method according to one or more embodiments herein;

FIG. 12 shows a graphical representation of adsorption capacity (qₑ) for certain heavy metal ions with respect to the feed solution pH from an experiment utilizing an adsorptive desalination and disinfection system and method according to one or more embodiments herein;

FIG. 13 is a series of illustrations of agar plates after exposure to treated and untreated water samples and incubation, wherein the treated samples were produced by an adsorptive desalination and disinfection system and method according to one or more embodiments herein;

FIG. 14 is a side elevation view of a schematic of a fixed-bed column for experiments utilizing an adsorptive desalination and disinfection system and method according to one or more embodiments herein;

FIG. 15 is a side elevation view of a schematic of a filter cartridge for experiments utilizing an adsorptive desalination and disinfection system and method according to one or more embodiments herein;

FIG. 16 is a side elevation view of a schematic of an experimental adsorptive desalination and disinfection system according to one or more embodiments herein;

FIG. 17A shows a graphical representation of adsorption efficiency after 24 hours for sorbent for sodium (Na⁺), calcium (Ca⁺), magnesium (Mg⁺²), and potassium (K⁺) ions with respect to concentration from an experiment utilizing an adsorptive desalination and disinfection system and method according to one or more embodiments herein;

FIG. 17B shows a graphical representation of salinity removal efficiency after 24 hours for sorbent with respect to initial salinity from an experiment utilizing an adsorptive desalination and disinfection system and method according to one or more embodiments herein;

FIG. 17C shows a graphical representation of adsorption efficiency after 24 hours for sorbent for calcium (Ca⁺²) ions with respect to concentration from an experiment utilizing an adsorptive desalination and disinfection system and method according to one or more embodiments herein;

FIG. 17D shows a graphical representation of adsorption efficiency after 24 hours for sorbent for magnesium (Mg⁺²) ions with respect to concentration from an experiment utilizing an adsorptive desalination and disinfection system and method according to one or more embodiments herein;

FIG. 17E shows a graphical representation of adsorption efficiency after 24 hours for sorbent for potassium (K⁺) ions with respect to concentration from an experiment utilizing an adsorptive desalination and disinfection system and method according to one or more embodiments herein;

FIG. 17F shows a graphical representation of adsorption efficiency after 24 hours for sorbent for sodium (Na⁺) ions with respect to concentration from an experiment utilizing an adsorptive desalination and disinfection system and method according to one or more embodiments herein;

FIG. 18A shows a graphical representation of adsorption desalination efficiency of the pristine sorbent with respect to different contact time from an experiment utilizing an adsorptive desalination and disinfection system and method according to one or more embodiments herein;

FIG. 18B shows a graphical representation of adsorption efficiency after 24 hours comparing unconditioned and conditioned sorbent for sodium (Na⁺), calcium (Ca⁺), magnesium (Mg⁺²), and potassium (K⁺) ions from an experiment utilizing an adsorptive desalination and disinfection system and method according to one or more embodiments herein; and

FIG. 18C shows a graphical representation of adsorption efficiency in removal of sodium and other ions after 24 hours comparing unconditioned and conditioned sorbent along with other traditional sorbents from an experiment utilizing an adsorptive desalination and disinfection system and method according to one or more embodiments herein.

### DETAILED DESCRIPTION

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not necessarily made to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments.

Desalination, particularly of saltwater, is an important and growing market which can provide enhanced availability to water that is necessary for technological and societal development. Desalination is the process of removing salts and/or other minerals and contaminants from saltwaters, and/or wastewater effluents. Desalination is a particularly useful process due to the much higher volumes of saltwater available across the globe, versus fresh water. Indeed, the global water desalination equipment market size was estimated at $15.53 billion USD in 2022 and is anticipated to expand at a compound annual growth rate (CAGR) of 9.4% from 2023 to 2030. Factors including growing population, rapid urbanization and rising water scarcity in several parts of the world are expected to drive the demand for water desalination equipment, particularly from seawater and brackish water sources.

Regarding these sources, the seawater segment led the market and accounted for 60.1% of the global revenue share in 2022. However, the brackish water segment is estimated to witness growth at a CAGR of 9.4% from 2023 to 2030. Indeed, the presence of abundant sources of brackish water that can be used to produce freshwater (i.e., water with at least salts removed) is predicted to drive demand for brackish water desalination technology throughout North America, South America, and Asia Pacific. In fact, desalinating brackish water over seawater is advantageous due to the high recovery rate when compared to desalination of seawater using similar processes. For example, for the same process, seawater desalination produces around 50% freshwater, whereas brackish water produces about 90% freshwater.

However, the increasing scarcity of potable water is expected to drive increased demand for saltwater desalination, regardless of source. Some of the current customary methods of desalination include thermal distillation, electrodialysis, and reverse osmosis. Thermal distillation (TD) involves boiling saltwater and condensing vapor therefrom, which provides fresh water. Electrodialysis (ED) involves passing a current through saltwater with one or more ion-selective membranes between. Reverse osmosis (RO) is a separation process which utilizes pressure and a selectively permeable membrane. Each of these is energy intensive and can have one or more additional limitations which hamper use with various types of saltwater and/or at large scale.

Currently, the growing necessity of treating seawater and brackish water to safeguard freshwater supplies is predicted to drive demand for and further advanced development of desalination technology. Indeed, one of the newest methods for desalination, introduced in 2005, is adsorption desalination. Adsorption desalination is a phase transfer process that occurs at the interface between a solid and an aqueous phase where salt ions (the adsorbate) adsorb on the surface of porous solids (the sorbent) via physical interactions (such as van der Waals interaction and hydrogen bonding) and/or chemical bonding. Adsorption can be reversed, i.e., desorption, especially physical adsorption, to regenerate the adsorbent, which is key for the development of practical processes. Porous materials possess a unique set of properties, such as high specific area and pore volume, and fluid permeability, and hence provide high adsorption capacity, fast adsorption kinetic and good selectivity.

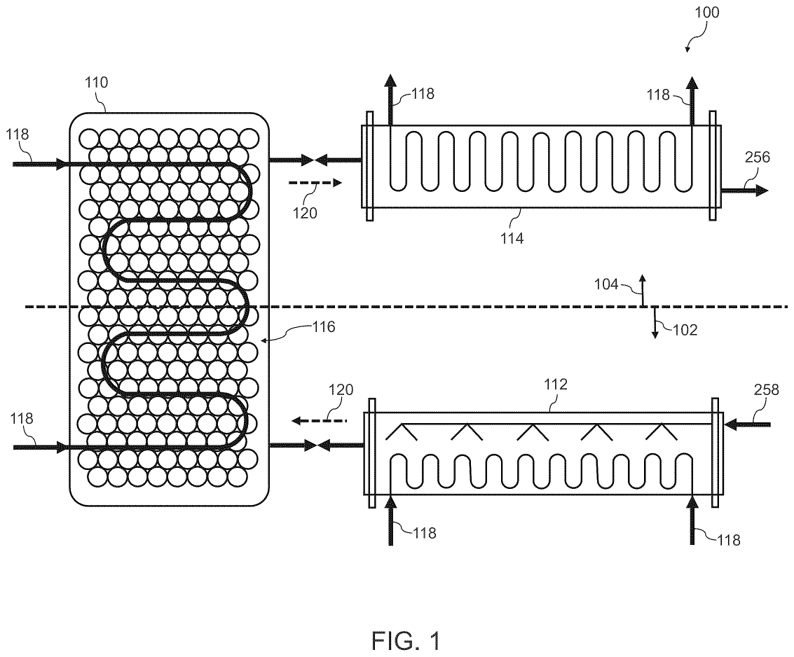

In embodiments, a typical adsorption desalination system 100 consists of a reactor 110, an evaporator 112, and a condenser 114 as illustrated in FIG. 1. In the adsorption phase 102, saltwater 258 (such as brine) enters the evaporator 112, where a phase change from liquid to vapor occurs, due to the application of heat 118. Subsequently, the water vapor 120 is adsorbed by dry sorbents 116 housed within the reactor 110. Once these sorbents 116 reach saturation with adsorbed water, the desorption phase 104 ensues to regenerate the sorbents 116 by using thermal energy, such as that from solar collectors or waste heat stream, to release water vapor 120 from the reactor 110 into the condenser 114, where it is condensed and freshwater 256 is obtained.

Adsorption desalination systems 100 offer a more sustainable and environmentally friendly alternative to customary desalination methods, resulting in reduced electricity consumption and greenhouse gas emissions. For example, as compared to customary an RO method and a Multi-Effect Distillation (MED) desalination method (a Thermal Distillation process), adsorption desalination systems 100 exhibit significantly lower electricity consumption, of around 1.38 kWh/m3, which is almost one-third of the consumption of these customary methods. Also, adsorption desalination exhibits lower corrosion and fouling on tube materials, due to the lower evaporation temperatures of saline water. Further, the system's design allows for the potential co-generation of freshwater 256 and a cooling effect. Thereby, the system 100 and process can allow for the use of high-salinity water sources while leaving a reduced carbon footprint.

Moreover, adsorption desalination systems 100 can replace or be combined with various customary desalination methods. For example, adsorption desalination systems 100 can effectively desalinate high-salinity brine to produce high-quality potable water, making them an ideal candidate for integration with customary RO systems to address the problem of brine disposal and reduce specific energy consumption. Likewise, adsorption desalination systems 100 can also be used to reduce the salinity of a saltwater feed for a customary ED system, helping make such a system more economical.

Recent developments regarding adsorption desalination systems 100 and methods have centered on acceptable sorbents 116. While a wide variety of sorbents 116, such as physical, chemical, and composites, have been synthesized and extensively investigated in other sorption-based systems (e.g., thermal energy storage, chillers, and heat pumps), the selection of sorbents 116 for application in adsorption desalination (AD) systems 100 has been somewhat limited. Microporous silica gel is one of the most historically common adsorbent materials in AD systems 100 due to its favorable sorption properties. Other recently studied physical adsorbents include metal-organic frameworks (MOFs), inorganic composites, and carbon nanotubes. For example, recent studies have explored the use of different types of metal-organic frameworks (MOFs) for the removal of salt ions from seawater, including alginic acid-based Cu-MOF-incorporated sorbents exhibiting excellent salt ion removal rates of up to 94.3% for high-concentration seawater. This high removal rate is generally attributed to the negatively charged chemical functional groups, such as carboxyl and hydroxyl groups, present in the alginic acid matrix that coordinate with Cu ions. The fast adsorption kinetics of the hybrid adsorption desalination technique also opens the possibility of designing dynamic ion treatment systems, providing higher freshwater yields than static adsorption systems.

However, these sorbents 116 often have very specific characteristics, such as a specific surface level charges, which limit their effectiveness in a desalination process and/or a disinfection process. That is, a particular sorbent 116 with a specific surface charge may remove either cations or anions but generally not both. Thereby, a process to remove both would generally require two separate sorbents 116 which increases the complexity and cost of the desalination process. Moreover, both customary systems and methods and current adsorption desalination systems 100 and methods are limited in their ability to eliminate microbial contaminants and are not produced from environmentally benign materials. Also, many of the recently explored sorbents 116 have high costs that hinder their feasibility for large-scale applications.

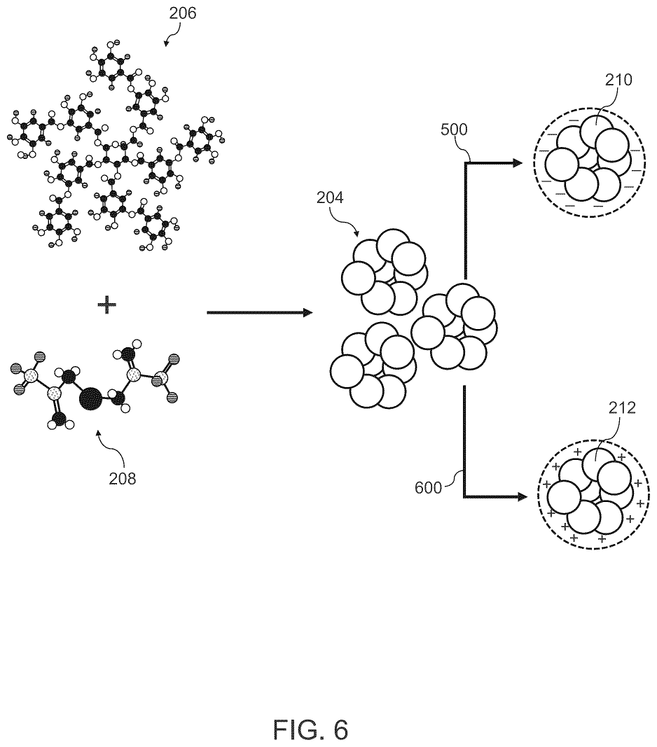

In aspects, the present disclosure provides for the use of an amphoteric sorbent 202 which is configured to be conditioned to exhibit anionic behavior under a first set of conditions and cationic behavior under a second set of conditions. Indeed, in at least one embodiment herein, iron (III)-tannate 204, which has demonstrated some significant benefits as a sorbent for lithium recovery from brines, is utilized as an amphoteric sorbent 202 for a desalination process 300. Indeed, in the general schematic of FIG. 6, tannic acid 206 and iron (II)-acetate 208 may be utilized to form an iron (III)-tannate 204 which can be conditioned 500 to be an anionic sorbent 210—which exhibits anionic behavior— or conditioned 600 to be a cationic sorbent 212—which exhibits cationic behavior. Moreover, the present disclosure, in aspects, further provides for the use of a sorbent 202 that is further capable of both desalination and disinfection.

Specifically, iron (III)-tannate 204 demonstrates microporosity, amphoteric surface properties, and colloidal stability in water at a wider range of pH as well as heavy metal adsorption that highlight its potential utility as an amphoteric sorbent 202 for separation, extraction, and upcycling of anions, cations, toxic heavy metals, valuable minerals, and organic contaminants from water resources. Indeed, the utilization of iron (III)-tannate 204, in particular, provides the ability and benefit for the desalination process 300 to utilize a single sorbent 202, in embodiments. In fact, iron (III)-tannate 204 exhibits merits as an amphoteric sorbent 202 in effectively eliminating total dissolved salts (TDS) and heavy metal traces from a range of saltwater 258, such as seawater 254 or brines having TDS concentrations spanning from 1000 mg/L to 24,000 mg/L, in embodiments. Also, utilization of iron (III)-tannate 204 as a single sorbent 202 leads to a less complex system 200 and process 300 which can provide the desired desalination and remediation efficiency and other effects, such as antifouling capability, minimal brine discharge, and minimal waste accumulation, at a reduced cost. Moreover, the use of an amphoteric sorbent 202, particularly iron (III)-tannate 204, provides a dual benefit of providing disinfection along with desalination, further enhancing the efficiency and low cost of the system 200 and associated process 300.

Additionally, iron (III)-tannate 204 is also desirable due to its origin from a natural polyphenol, a readily available biomass byproduct derived from agricultural waste. Indeed, tannic acid (TA) 206, utilized to form iron (III)-tannate 204, is a natural polyphenol present in various plants and tree barks and can be extracted in large scale for low cost. Owing to TA's pyrogallol and catechol structural units, it exhibits valuable chemical and physical properties, including antioxidant and antibacterial properties as one of the cheapest natural abundant functional materials. TA's five pyrogallol and five catechol groups provide multiple bonding sites with diverse interactions, including hydrogen bond, ionic bond, coordination bond, and hydrophobic interactions as well as rich in oxygen sites for selective metal ion binding.

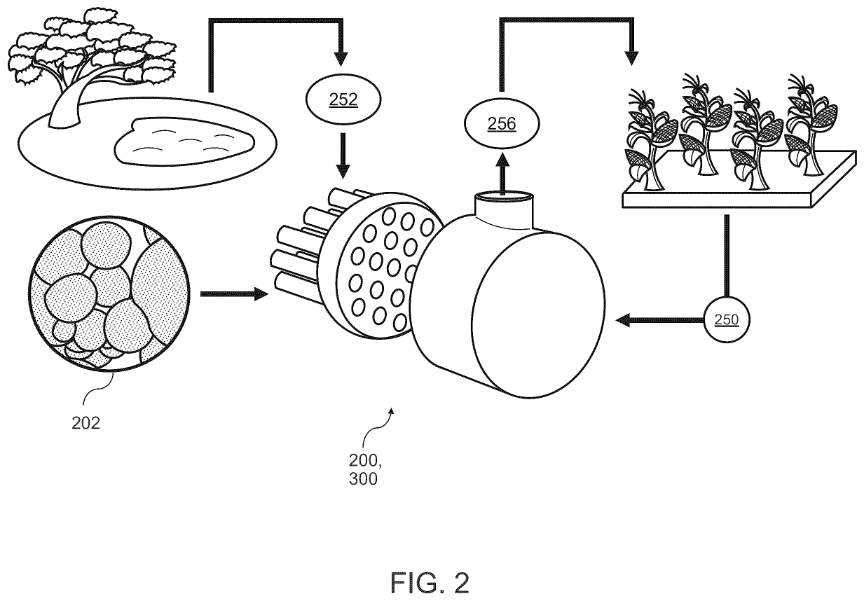

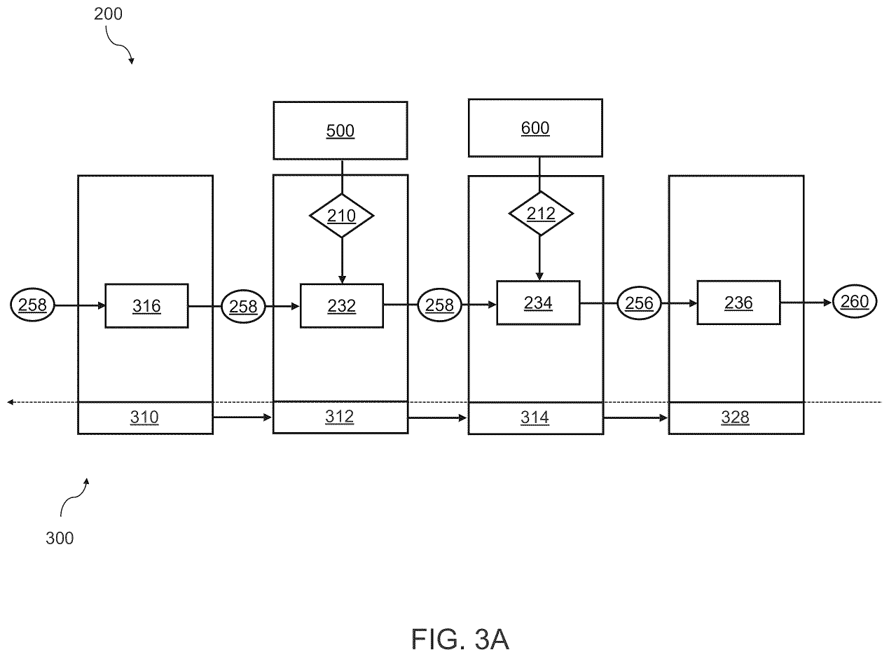

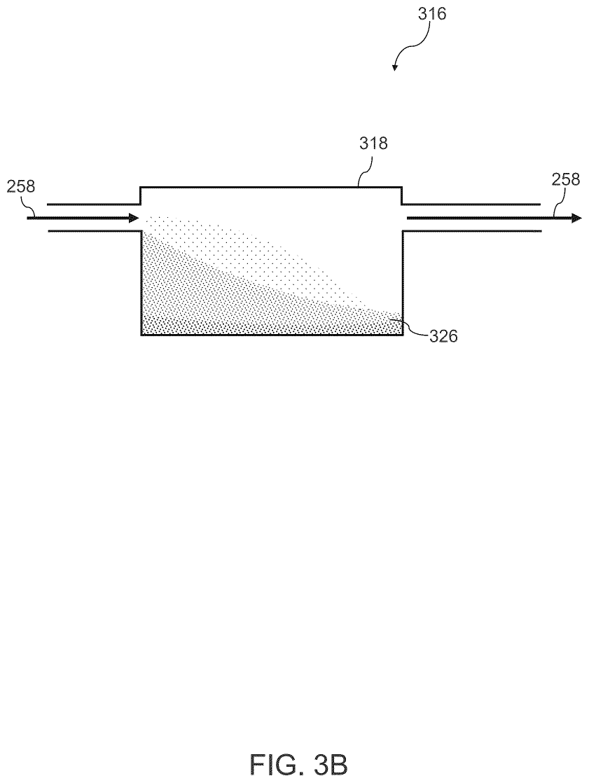

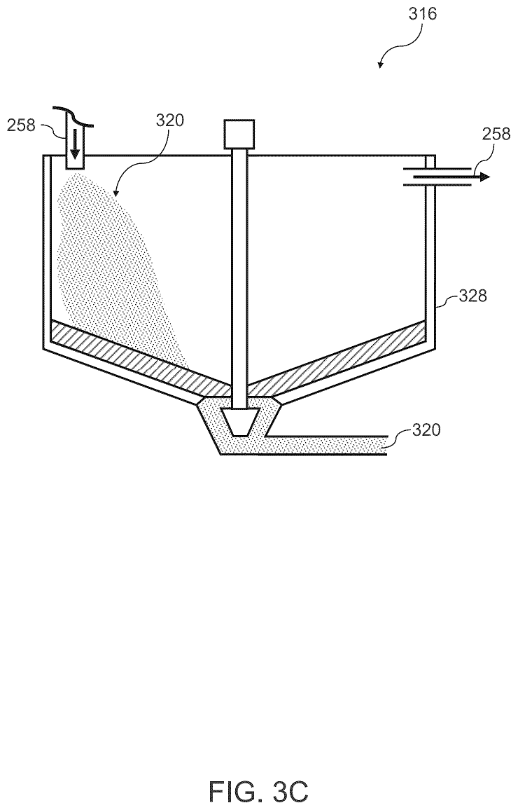

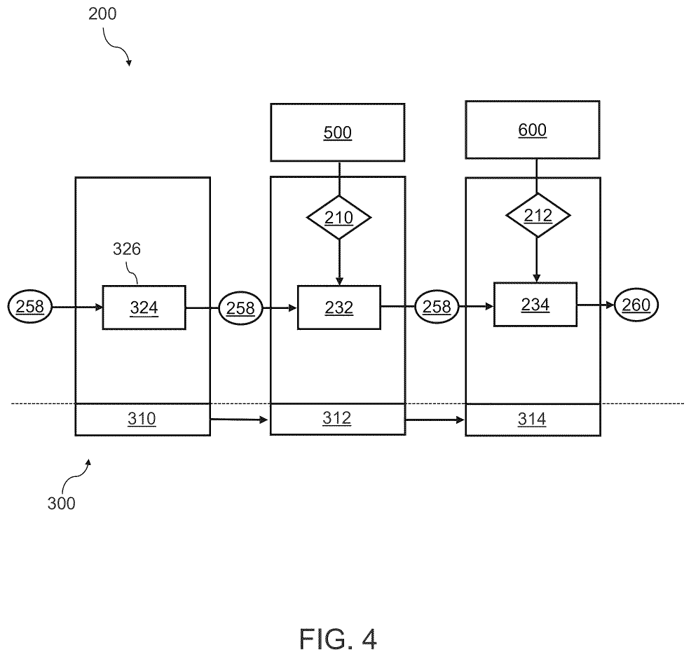

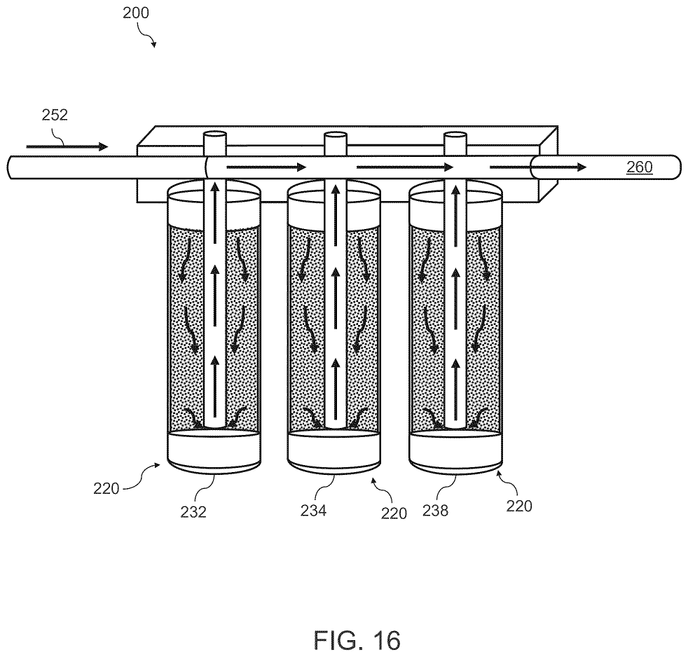

Thereby, the present disclosure provides, in embodiments, a rapid and efficient point-of-use desalination and disinfection system 200 (similar to that of FIG. 16) and method 300 (similar to those of FIGS. 3A and 4) capable of operating at ambient conditions with zero carbon emissions, being both cost-effective and environmentally friendly with a small footprint. Additionally, the present disclosure provides, in embodiments, a system 200 and method 300 that provides treatment of industrial drainage, e.g., agricultural drainage 250, utilizing a bio-based sorbent 202 manufactured from agricultural byproducts, conserving water, and eliminating brine discharge and waste accumulation to minimize environmental impact and, in agricultural uses, to promote soil health and enhance crop production. Indeed, in embodiments, the present disclosure provides a dual-functional sorbent-based remediation system 200, wherein agricultural drainage 250 and brackish groundwater 252 may be treated to aid in crop irrigation and soil health such as shown in FIG. 2. Accordingly, the use of the system 200 and method 300, such as demonstrated in FIG. 2, provides an advanced brackish water 252 and agricultural drainage 250 remediation technology to promote agricultural resilience and a circular water economy through climate smart practices and agricultural byproduct reuse.

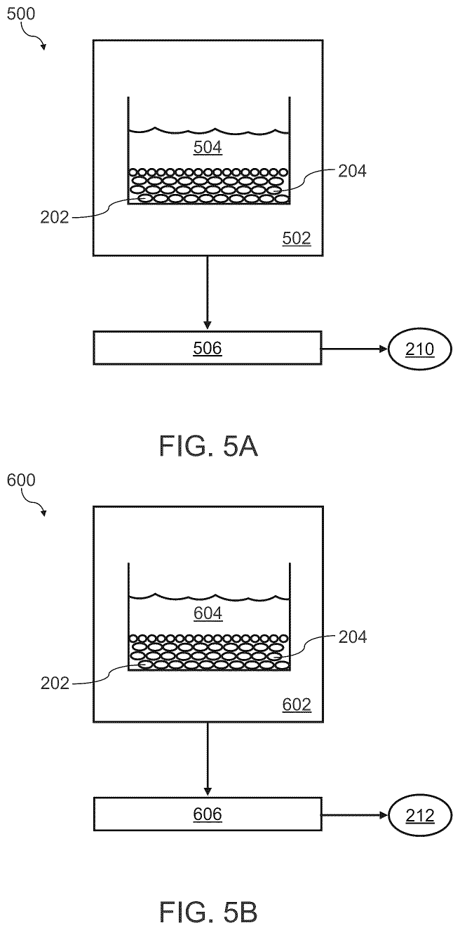

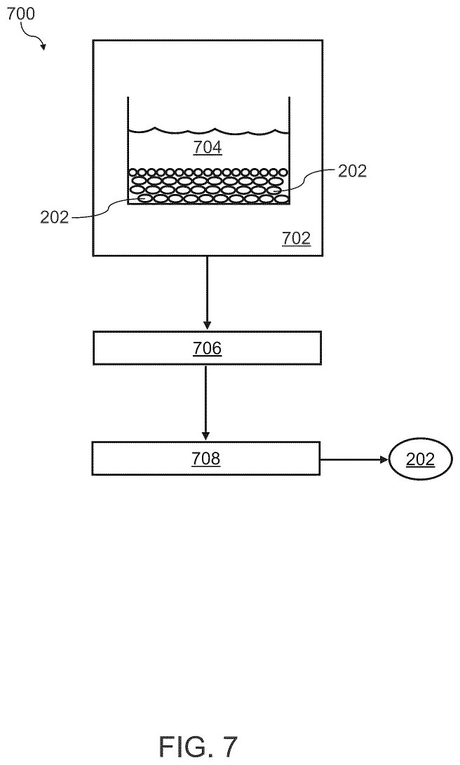

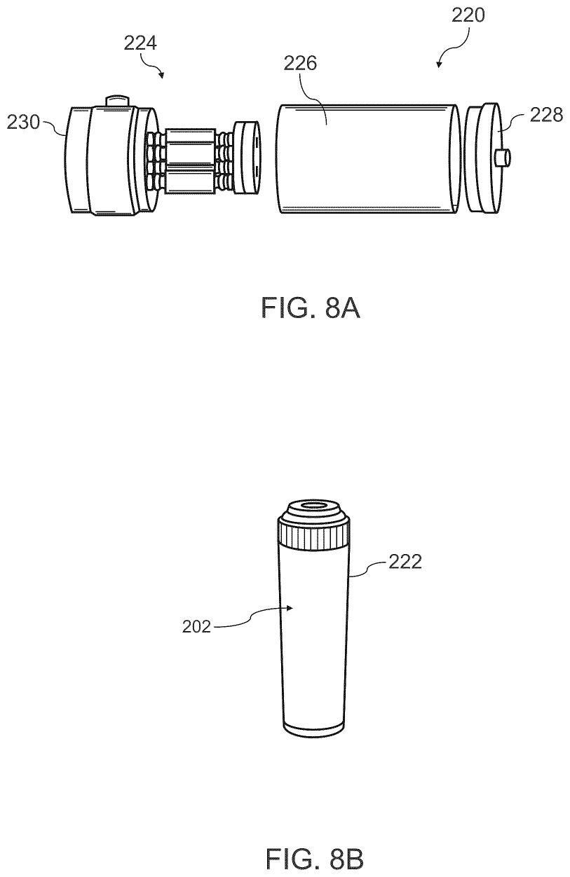

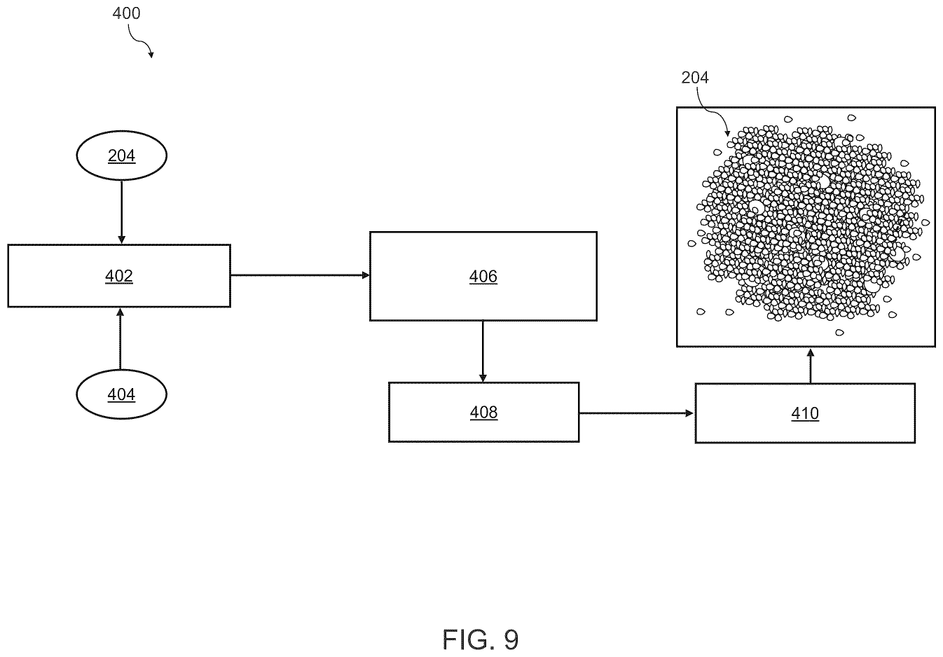

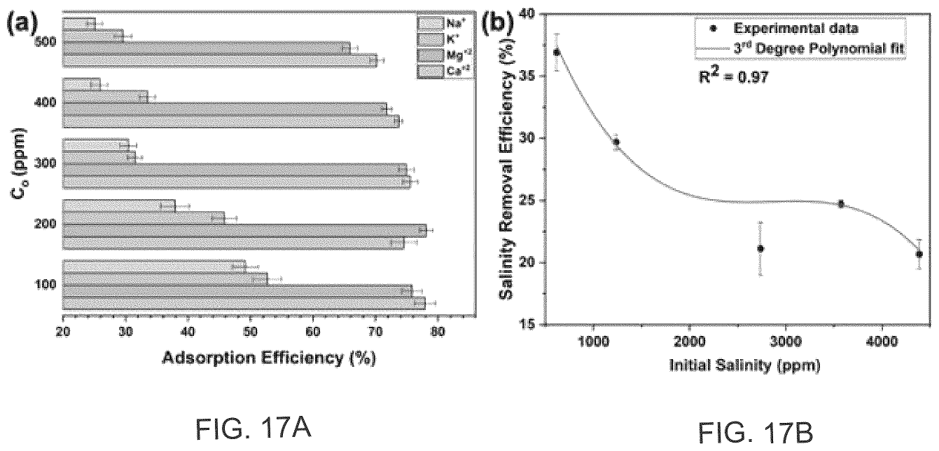

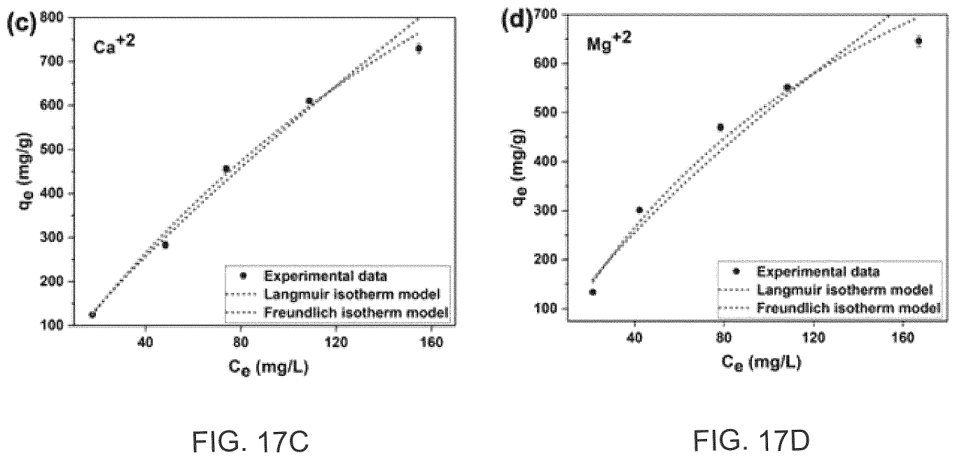

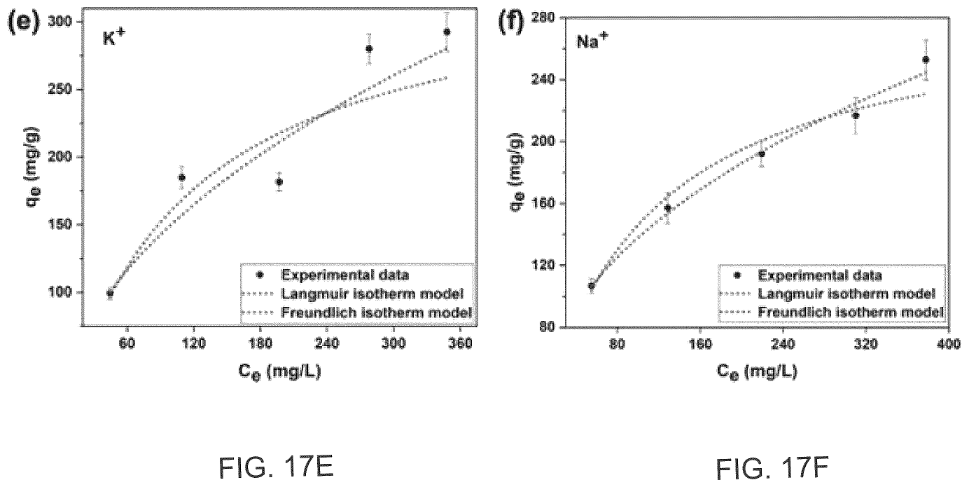

Moreover, the present disclosure also provides, in embodiments, methods of polymer impregnating 400 an amphoteric sorbent 202, as in FIG. 9, which can provide a more useful format for utilization in a portable filter cartridge 222. In further embodiments, the disclosure also provides for a filter cartridge assembly 220, as in FIG. 8, that has a filter housing 224 configured to utilize such a portable filter cartridge 222 and configured to be utilized with the amphoteric sorbent 202 in a dual desalination and disinfection process 300, like the setup of FIG. 17. Additionally, the present disclosure also provides methods 500,600 of conditioning the sorbent 202 to take advantage of the anionic and cationic behaviors thereof, as in FIGS. 5A and 5B, and of regenerating 700 the sorbent 202 after use, to return the sorbent 202 to a useful and productive format as in FIG. 7, in embodiments. Indeed, the conditioning 500, 600 and regeneration 700 of the sorbent 202, particularly that disposed in the portable and replaceable filter cartridges 212, allows for reusability which further enhances the simplicity and efficiency of the methods and components thereof in embodiments.

In embodiments, as in those of FIGS. 3A and 4, a process 300 for adsorption desalination and disinfection of saltwater 258 utilizing a polymer impregnated amphoteric sorbent comprises providing a volume of saltwater 310, passing the volume through a first filter cartridge assembly 232 configured to disinfect and remove cations from the volume passed therethrough 312, and passing the passing the volume through a second filter cartridge assembly 234 configured to disinfect and remove anions from the volume passed therethrough 314. In embodiments, the first filter cartridge assembly 232 comprises an anionic sorbent 210, which is a polymer impregnated iron (III)-tannate amphoteric sorbent 204 configured to exhibit anionic behavior. In embodiments, the second filter cartridge assembly 234 comprises a cationic sorbent 212, which is a polymer impregnated iron (III)-tannate amphoteric sorbent 204 configured to exhibit cationic behavior.

Regarding the volume of saltwater 258, it is of note that the volume of saltwater 258 can have varied levels of salinity. Indeed, in various embodiments, the volume may have high salinity, like seawater 254, an intermediate amount of salinity, like brine or brackish water 252, or be freshwater 256. In embodiments, the salinity levels, considered herein, are generally (in grams of salt per liter of water) below 0.05% for freshwater, above 3% for seawater, and between 0.05% and 3% for brackish water. However, herein the term “brine” may be utilized to refer to water above 5%.

In embodiments, the volume passed through both filter cartridge assemblies 220 is desalinated and disinfected, becoming cleaned water 260 as in FIG. 4. In certain embodiments, the system 200 and process 300 may be utilized for one or both of desalinating and disinfecting a volume of water. Indeed, water exiting the first filter cartridge assembly 232 has cations removed, such as Na⁺, K⁺, Mg⁺², and Ca⁺² along with being disinfected. Similarly, water exiting the second filter cartridge 234 has all anions removed along with being disinfected. That is, in at least one embodiment, the systems 200 and methods 300 herein might be utilized for disinfection, without regard for desalination, or vice versa. However, the dual functionality of the methods herein is beneficial and desirable in embodiments. Accordingly, while a volume of saltwater 258 is referenced as the input of the system 200 and process 300, wherein it is desalinated and disinfected to highlight the dual functionality, a volume of freshwater 256 may be input to only be disinfected by the system 200 and process 300, such as by removal of heavy metal traces and microbial contaminants. That is, while the term saltwater 258 is utilized herein, it is not meant to limit the input to only brackish water 252, seawater 254, and brines, but can encompass freshwater 256 that still would benefit from such system 200 and process 300. Moreover, while the term saltwater 258 is utilized herein, the input, and therefore the term saltwater 258, may also encompass agricultural drainage 250 so that such water might be reused. Accordingly, it is understood that the phrase volume of saltwater 258 is utilized herein to highlight the dual effect of the system 200 and method 300, not to limit the input to just saltwater 258.

In embodiments, the volume of saltwater 258 may have particulate 320 removed prior to utilization in system 200 and process 300, by settling 316 (as in FIG. 3A) and/or filtering 324 (as in FIG. 4) the volume to remove at least a portion, if not all, of the particulate 320 therefrom in certain embodiments. Herein, the term “particulate” refers to solids that are in suspension but not generally dissolved such that these solids may settle under the force of gravity or be separated by filtering. In embodiments, settling 316 may be performed by introducing the volume of saltwater 258 to a settling basin 318 where the particulate 320 can fall out and the volume of saltwater 258 having particulate removed, can be siphoned off, as in FIG. 3B. In addition or alternative to the settling basin 318, settling 316 may also be performed by introducing the volume of saltwater 258 to a clarifier 322 having a mechanism for collecting and moving settled particulate 320, such as a scraping arm, and a sludge withdrawal opening for accepting and removing the settled particulate 320 sludge where the volume of saltwater 258 having particulate removed, can be siphoned off, as in FIG. 3C. In embodiments, filtering 324 involves passing water through a particulate filter 326 to remove the particulate 320. In embodiments, both settling 316 and filtering 324 may be utilized, to ensure that large particulate is removed and is less likely to cause clogging in any of the filter cartridge assemblies of the systems 200 and methods 300.

In additional embodiments, alternative methods may be utilized to remove particulate from a volume of saltwater 258 other than settling 316 (i.e., sedimentation) and filtering 324. The removal of particulate 320 from the volume of saltwater 258 prior to passing the volume through one or more of the filter cartridge assemblies 220 prevents clogging and enhances the longevity of the filter cartridge assemblies 220 in embodiments. Moreover, the enhancement in longevity contributes to reduced complexity and costs associated with the system in aspects.

In particular embodiments, the amphoteric sorbent 202 utilized in the filter cartridge assemblies 220 can be conditioned, i.e. activated, to exhibit anionic or cationic behavior as shown in FIGS. 5A, 5B, and 6. Depending upon the behavior exhibited, such activation serves to configure a given portion of the sorbent to be particularly effective at removing anions or cations. In at least one embodiment, conditioning the sorbent 202 comprises contacting the sorbent with an acidic 604 or basic 504 fluid, such as by soaking, for a period of time. Herein, use of the term “soaking” is also meant to encompass contacting and other forms of exposure which are suitable to cause the specified activation.

For example, a polymer impregnated iron (III)-tannate amphoteric sorbent 204, like that of the first filter cartridge assembly 232 shown in FIGS. 3A and 4, can be soaked in a weak base 504, such as ethylene glycol or ammonium hydroxide (NH₄OH), for a period of time to configure it to exhibit anionic behavior—activate a negative sorbent surface charge—and produce an anionic sorbent 210, as in FIG. 5A. Indeed, exposure of the iron (III)-tannate sorbent 204 with a weak base 504 deprotonates the hydroxyl groups within the catechol units to generate a negatively charged surface. Thereby, a polymer impregnated iron (III)-tannate amphoteric sorbent 204 can undergo an anionic conditioning process 500 by soaking 502 and drying 506 to generate an anionic sorbent 210.

In embodiments, conditioning 500 the polymer impregnated iron (III)-tannate amphoteric sorbent 204 to form an anionic sorbent 210 of the first filter cartridge assembly 232 involves generating a pH above 5.0, such as 7.0, for the sorbent such as through soaking 502 it with a weak base 504, such as ethylene glycol or ammonium hydroxide, as in FIG. 5A. Herein, a pH of 7.0 is identified as it provides a more complete activation of the negatively charged surface within a particular time at or above such pH. Moreover, it is understood that this conditioning 500 is only for the initial generation of an anionic sorbent 210 and during operation in a system 200 and process 300 the surface level charge of the iron (III)-tannate amphoteric sorbent 204 may be affected by the pH of the volume of saltwater 258.

In an additional embodiment, conditioning 500 the polymer impregnated iron (III)-tannate amphoteric sorbent 204 to form an anionic sorbent 210 of the first filter cartridge assembly 232 involves soaking 502 the sorbent in a 1:1 w/v ratio of amphoteric sorbent 202 to a weak base 504, such as ethylene glycol or ammonium hydroxide. In a still further example, conditioning 500 the polymer impregnated iron (III)-tannate amphoteric sorbent 204 to form an anionic sorbent 210 of the first filter cartridge assembly 232 involves soaking 502 the sorbent for a 24-hour period and thereafter air drying 506 the sorbent for several hours. Through the foregoing example embodiments, an amphoteric sorbent 202, such as the polymer impregnated iron (III)-tannate amphoteric sorbent 204, can be activated to become an anionic sorbent 210 that exhibits anionic behavior (through a negative surface charge) and which can remove cations, such as those prevalent in saltwater 258. In all of the foregoing examples, the weak base 504 may be a solution with a certain percentage of a particular basic fluid, such as a 2.8% ammonium hydroxide solution. In at least one embodiment, the cations removed include one or more of sodium atom cations, potassium atom cations, magnesium atom cations, silver atom cations, cadmium atom cations, lead atom cations and calcium atom cations.

In another example, a polymer impregnated iron (III)-tannate amphoteric sorbent 204, like that of the second filter cartridge assembly 234 shown in FIGS. 3A and 4, can be soaked in a weak acid 604, like vinegar, for a period of time to configure it to exhibit cationic behavior—activate a positive sorbent surface charge—and produce a cationic sorbent 212 as in FIG. 5B. Indeed, exposure of the iron (III)-tannate sorbent 204 with a weak acid 604 induces a positively charged surface, such as through saturation with protons (H⁺). Thereby, a polymer impregnated iron (III)-tannate amphoteric sorbent 204 can undergo a cationic conditioning process 600 by soaking 602 and drying 606 to generate a cationic sorbent 212.

In embodiments, conditioning 600 the polymer impregnated iron (III)-tannate amphoteric sorbent 204 to form a cationic sorbent 212 of the second filter cartridge assembly 234 involves generating a pH below 4.0, such as 3.5, for the sorbent such as through soaking 602 it with a weak acid 604, like vinegar, as in FIG. 5B. Herein, a pH of 3.5 is identified as it provides a more complete activation of the positively charged surface within a particular time at or below such pH. Moreover, it is understood that this conditioning 600 is only for the initial generation of a cationic sorbent 212 and during operation in a system 200 and process 300 the surface level charge of the iron (III)-tannate amphoteric sorbent 204 may be affected by the pH of the volume of saltwater 258.

In an additional embodiment, conditioning 600 the polymer impregnated iron (III)-tannate amphoteric sorbent 204 to form a cationic sorbent 212 of the second filter cartridge assembly 234 involves soaking 602 the sorbent in a 1:1 w/v ratio of amphoteric sorbent to weak acid 604, such as vinegar. In a still further example, conditioning 600 the polymer impregnated iron (III)-tannate amphoteric sorbent 204 to form a cationic sorbent 212 of the second filter cartridge assembly 234 involves soaking 602 the sorbent for a 24-hour period and then air drying 606 the sorbent for several hours. Through the foregoing example embodiments, an amphoteric sorbent 202, such as the polymer impregnated iron (III)-tannate amphoteric sorbent 204, can be activated to become a cationic sorbent 212 that exhibits cationic behavior (through a positive surface charge) and which can remove anions. In all of the foregoing examples, the weak acid 604 may be a solution with a certain percentage of a particular basic fluid. Indeed, vinegar is a solution of water and between 4-6% acetic acid.

Although the sorbent of the first filter cartridge assembly 232 is disclosed as being an anionic sorbent 210 and the sorbent of the second filter cartridge assembly 234 is disclosed as being a cationic sorbent 212, it is also understood that the reverse may also be utilized. That is, the polymer impregnated iron (III)-tannate amphoteric sorbent 204 of the first filter cartridge assembly 232 can be activated to become a cationic sorbent 212 that exhibits cationic behavior and the polymer impregnated iron (III)-tannate amphoteric sorbent 204 of the second filter cartridge assembly 234 can be activated to become an anionic sorbent 210 that exhibits anionic behavior.

In further embodiments, the method 300 further comprises passing the volume of water through a third filter cartridge assembly 328, in addition to the first and second, to remove additional trace metal ions and further disinfect the volume of water, as shown in FIG. 3A. That is, the third filter cartridge assembly 236 can take freshwater 256 that is desalinated and disinfected by the first two assemblies and remove any further impurities (such as trace heavy metals) and/or complete disinfection to make clean water 260 (i.e., water that is free from impurities). Indeed, in at least one embodiment, the third filter cartridge assembly 236 contains an un-conditioned and un-activated amphoteric sorbent 202, such as iron (III)-tannate 204. Thereby, the third filter cartridge assembly 236 may take advantage of iron (III)-tannate's ability to remove heavy metals, even when not conditioned. However, in various embodiments, the amphoteric sorbent 202 of the third filter cartridge assembly 236 may be conditioned or activated to be an anionic sorbent 210 or cationic sorbent 212. Indeed, the choice may be dependent upon the characteristics of the volume of saltwater 258 the system 200 or process 300 is intended to treat.

Moreover, in certain embodiments, the third filter cartridge assembly 236 can utilize a different sorbent and/or method of desalination and/or disinfection altogether from iron (III)-tannate 204. For example, the third filter cartridge assembly 236 could comprise a chlorine-based disinfection method. Moreover, it is understood that utilization of a third filter cartridge assembly 236 does not necessarily mean that the combination of the first and second filter cartridge assemblies 232, 234 failed to produce water meeting specified cleanliness standards, e.g., clean water 260. Instead, utilization of a third filter cartridge assembly 236 may instead increase the efficiency and redundancy of the system 200 and method 300 by providing a reserve filtering means for cases where functionality of the first or second filter cartridge assembly 232, 234 is impaired. Thereby, functionality of the system 200 and method 300 can be extended beyond a failure or impairment to one of the filter cartridge assemblies 220. In embodiments, both the desalination process (including the first and second filter cartridge assemblies) and the tertiary treatment (including the third filter cartridge assembly) utilize iron (III)-tannate 204, providing a simple, efficient, system/method that benefits from the many beneficial characteristics and dual functionality of iron (III)-tannate 204. Such benefits, as outlined previously, include that iron (III)-tannate 204 is a multifunctional bio-based material with the capability of performing both adsorption and desorption operations, as well as disinfection and removal of removal of contaminants.

In embodiments, a portion or the entire system 200 and method 300 for desalination and disinfection described above, and disclosed in FIGS. 3A and 4, is operated or carried out in ambient conditions. However, in embodiments, the conditions may be regulated for any of the embodiments of the system 200 and method 300 previously disclosed, particularly those by which the sorbent 202 is conditioned 500, 600.

In certain embodiments, the amphoteric sorbent 202 utilized in the filter cartridge assemblies 220 can be regenerated 700, as provided in FIG. 7, after a period of use, providing for the ability to reuse the sorbent 202, such as that stored in a portable filter cartridge 222. Indeed, regeneration 700 allows for a number of portable filter cartridges 222 to be cycled ensuring less downtime while utilizing the less complex method of this disclosure. In at least one embodiment, regenerating 700 the sorbent comprises contacting the sorbent 202 with an acid 704, such as vinegar, for a period of time. In one embodiment, the sorbent can be regenerated 700 by soaking 702 the sorbent 202 in a 1:1 w/v ratio of amphoteric sorbent 202 to an acid 704, like vinegar, for 24 hours, and then washing 706 the amphoteric sorbent in a 1:1 w/v ratio of sorbent 202 to water and drying 708 the sorbent 202 in air at ambient conditions for several hours as shown in FIG. 7. Thereby, a series of portable filter cartridges 222 may be cycled to always have a replacement ready and to minimize the amount of sorbent 202 required for the system 200 and method 300 overall.

In embodiments, one or more of the filter cartridge assemblies 220 comprise a housing 224 enclosing a portable filter cartridge 222 as in FIG. 8A. In at least one embodiment the filter housing 224 is selectively accessible to insert and remove a portable filter cartridge 222. Thereby, a portable filter cartridge 222 that has been conditioned can be inserted into a filter housing 224 for use and removed after use to be regenerated and replaced with another portable filter cartridge 222 that has been conditioned. In at least one embodiment, the filter housing 224 comprises a central cover 226 disposed between an inlet end cap 228 and a retentate end cap 230, so the portable filter cartridge 222 is enclosed within the central cover 226 and disposed between end caps 228, 230 and contacts fluid moving from the inlet end cap 228 to the retentate end cap 230. The utilization of such a filter housing 224 also allows for variability of the system 200 and method 300. For example, a portable filter cartridge 222 of one of the first, second or third filter cartridge assemblies can be swapped for one containing an anionic sorbent 210 or cationic sorbent 212 as needed. Thereby, the system 200 and method 300 can be varied to allow a volume of saltwater 258 to be passed through two portable filter cartridges 222 having anionic sorbent 210 exhibiting anionic behavior to ensure full removal of all cations before being passed through a portable filter cartridge 222 having cationic sorbent 212 exhibiting cationic behavior, or vice versa. In alternative embodiments, the arrangement and order or the sorbents can be in any variation capable of producing the desired level of desalination and/or disinfection in water. Indeed, in certain embodiments, varying the order by which the volume of saltwater 258 encounters the sorbent 202 may further enhance the disinfection of the volume. To enhance removability and portability, the filter cartridge may be configured as in FIG. 8B.

In use, embodiments of the system 200 and method 300 may be utilized to provide clean water by itself or may be utilized in conjunction with a customary desalination/disinfection method. In embodiments, systems 200 and methods 300 according to embodiments herein may pre-treat a feed for another desalination/disinfection method, to enhance the operation and longevity of such method. In alternative embodiments, systems 200 and methods 300 according to embodiments hereof may post-treat an output fluid from another desalination/disinfection method. That is the volume of saltwater 258 input into the system 200 and method 300 may be the output of initial separate desalination/disinfection system/method. In still yet another embodiment of use, additional filter cartridge assemblies 220 may be utilized beyond the first, second, and third to provide enhance functionality, particularly in circumstances where a volume of saltwater 258 is particularly dirty or has high salinity.

In embodiments of the foregoing system 200 and method 300, a polymer impregnated amphoteric sorbent 202 is utilized. Polymer impregnation 400 of the amphoteric sorbent 202 is configured to provide a functional, efficient format for the sorbent to contact fluid and be utilized in portable filter cartridges 222, in embodiments. In at least one embodiment, a method for polymer impregnating 400 an amphoteric sorbent 202, particularly iron (III)-tannate 204, comprises forming a combined solution 402 by mixing the amphoteric sorbent 202 in powder form into a polysulfone polymer solution 404, pumping 406 the combined solution into a volume of water to form solids containing the iron (III)-tannate 204, and removing 408 and drying 410 the solids from the water, as shown in FIG. 9. In embodiments, the polysulfone polymer solution 404 comprises a mixture of polysulfone with 1-methyl-2-pyrrolidone (NMP). Indeed, in certain embodiments, the polysulfone polymer solution 404 comprises approximately 5.5 grams of NMP for every 1 gram of polysulfone. In particular embodiments, 1 gram of iron (III)-tannate powder is mixed into every 6.5 grams of the polysulfone polymer solution. However, in other embodiments, approximately 1 gram of iron (III)-tannate powder 204 is dispersed into between 6.0 and 7.0 milliliters of polysulfone solution 404. Proper formation of solids in the volume of water can be affected by the mixture components, characteristics, and ratios, in embodiments and those provided form a particular successful embodiment.

This mixture of iron (III)-tannate 204 and polysulfone solution 404 can be pumped 406 into approximately 20 milliliters of deionized water, in embodiments. Indeed, in various embodiments the mixture is pumped 406 into the volume of water through a needle tip, such as an 18 gauge needle tip, disposed at a distance, such as 4 centimeters, above the surface of the volume of deionized water. In at least one embodiment, the mixture is pumped into the volume of water at a rate of 0.2 milliliters per minute. Proper formation of solids in the volume of water can be affected by the characteristics and arrangement of the needle tip, water, the volume of water itself, and the rate of pumping, in embodiments, and those provided form a particular successful embodiment.

In embodiments, the solids formed are generally spherical which can enhance their functionality within a portable filter cartridge 222. Moreover, the solids may be stored in the water for several hours, after formation, to ensure their quality relative to their functionality, in embodiments. Likewise, the solids may be dried 410 under certain conditions, such as at 80 degrees Celsius for several hours, to further ensure their quality relative to their functionality, in embodiments. Thereby, iron (III)-tannate sorbent 204, or any other amphoteric sorbent 202, may be polymer impregnated.

Although the provided embodiments disclose one method for forming a polymer impregnated amphoteric sorbent 202, it is understood that other steps and/or components may be utilized, in addition or in alternative to those outlined herein. Indeed, in embodiments a different polymer solution and different ratios may be utilized. In certain embodiments, a different polymer impregnated metal coordination framework may be utilized.

Hereby, the present systems 200 and methods 300 provide an efficient and rapid desalination technology for use with brackish water 252, brines, and seawater 254 in embodiments. In embodiments, the present methods provide desalination, purification, and disinfection of such water sources through the utilization of a solid-phase adsorption technology utilizing molecular sieves, particularly iron (III)-tannate microstructures 204, as the sorbent 202. In embodiments the sorbent 202 is amphoteric so that when conditioned at different pHs, the sorbents exhibit significant benefits and capabilities related to adsorption of dissolved salts and disinfection of contamination. To facilitate utilization of the sorbent 202, various methods of conditioning 500, 600 and regeneration 700 are provided which take advantage of the ability of the sorbent 202 to exhibit different characteristics under different circumstances and to allow for cleaning and reuse of the sorbent 202. Also, particular filter cartridge assemblies 220 are proposed herein which utilize a portable and replaceable filter cartridge 222 containing a sorbent 202, in embodiments. Thereby, these portable filter cartridges 222 can act as packed-bed sorbents 202 capable of various functions, such as the removal of cations or anions and/or disinfection, in embodiments. Moreover, a polymer impregnated amphoteric sorbent 202 and polymerization method 400 is provided herein which places the sorbent 202 in a format which makes it effective in packed-bed filter cartridges.

Embodiments and features have been described with reference to the drawings. It is to be understood that these descriptions are not limited to any single embodiment or any particular set of features, and that similar embodiments and features may arise, or modifications and additions may be made without departing from the scope of these descriptions and the spirit of the appended claims.

Further support for the present invention will be described and provided below through examples (and prophetic examples) relating to the system/method and components and features thereof. However, these examples are not intended to limit the present disclosure.

### EXAMPLES

### Example 1

### Adsorption Desalination on Various Brines

During the following comprehensive adsorption desalination investigations, batch and continuous fixed-bed adsorption employing custom glass columns packed with activated sorbents were utilized. Initially, batch adsorption studies were conducted with respect to different variables, such as adsorbent dose, contact time, and feed volume of brine solutions. For continuous fixed-bed column studies, parameters, such as flow rate, column diameter and height, and adsorbent dose were evaluated to optimize the adsorption efficiency. These variable experimental conditions for both batch and fixed-bed studies are listed in Table 1, below. The percentage of adsorption with respect to the initial concentration of each salt present was analyzed for different field collected brine samples. Batch and column operations were carried out as per Table 1 in triplicates and average values were considered for all these experiments. For the batch as well as column studies, the concentrations of alkali and alkaline cations were analyzed before and after experiment as per Standard Methods for Examination of Water and Wastewater. In batch adsorption studies, the experimental procedure follows introducing 20 mL samples of diverse brine compositions into the columns, maintaining at a specific contact time, allowing the system to attain adsorption equilibrium. The eluents collected after the designated contact time interval were analyzed via ICP-OES, allowing for the quantitative assessment of TDS removal efficiency of brine samples. For the column studies, the sorbent dose was optimized with respect to column dimensions.

TABLE 1
Experimental conditions for adsorption desalination studies

| System | Sorbent dose | Contact time | Feed volume |
|---|---|---|---|
| type | (g) | (min) | (mL) |
| Batch | 5, 10, and 20 | 30, 60, 120, | 20 |
| Adsorption | | 180, 240 | |
| | Flow rate | Bed height | Bed diameter |
| System type | (mL/min) | (inches) | (inches) |
| Fixed-bed | 25, 50, 100 | 10 | 1 |
| column | | | |

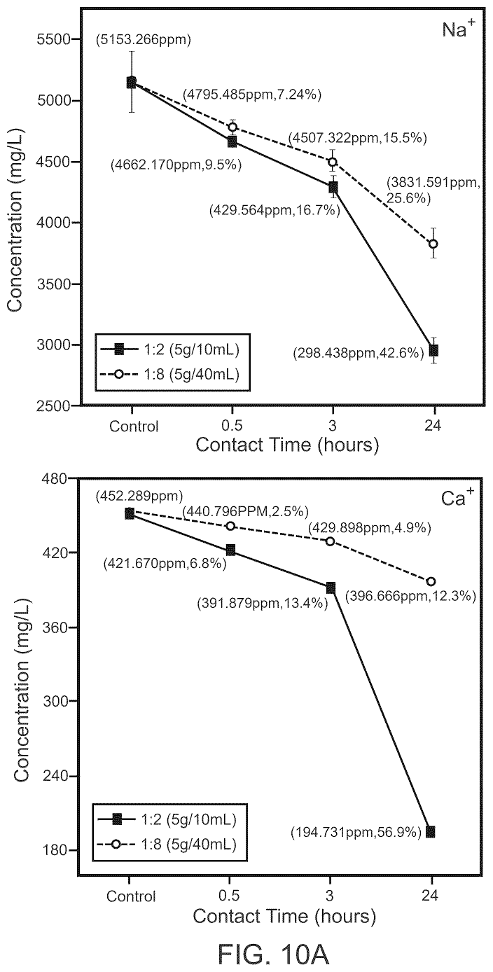

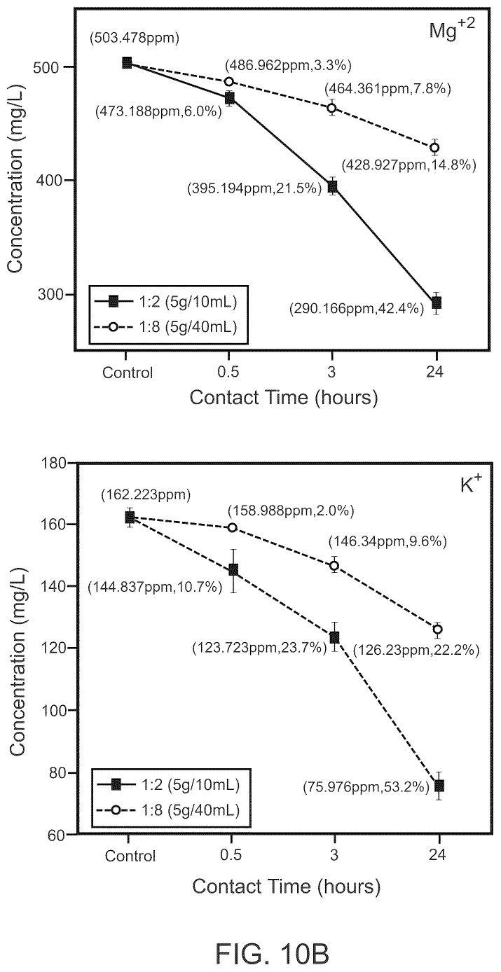

Variations in removal efficiency were exhibited in the outcomes of the batch adsorption studies for five distinct brine samples with diverse dissolved salt compositions. In particular, as the concentration of dissolved sodium chloride (NaCl) became notably elevated, the adsorption of sodium ions exhibited a decline. However, at lower NaCl concentration, an increase in the adsorption of alkali and alkaline cations was observed, that led to a significant removal efficiency exceeding 80%. Due to the complex nature of each brine sample in terms of the dissolve salt composition, the interplay and competition among the various cations and the adsorbent exerted an influential impact on the overall efficiency. Moreover, within the context of comparable cation concentration ranges, the results highlighted removal efficiencies exceeding 80% for each cation. Notably, in the case of magnesium, the removal efficiency reached 96% removal efficiency, signifying the promising performance of the sorbent under specific conditions. The case studies conduced for the five field-collected brine samples are summarized in Table 2, below. The batch studies conducted on seawater samples using the unmodified sorbents in an adsorption desalination setup have yielded promising outcomes, as shown in FIGS. 10A and 10B, supporting the potential effectiveness of the sorbent for seawater desalination.

TABLE 2
Batch studies for the desalination removal efficiency of five
field-collected brine samples (Contact time is 120 min).

Compositions (mg/L)

| Sample# | NaCl | KCl | MgSO4 | CaSO4 |
|---|---|---|---|---|
| 1 | 27,000 | 270 | 166 | — |
| % Removal | 37 | 54 | 14 | — |
| 2 | 18,270 | 558 | 327 | 665 |
| % Removal | 29 | 90 | 89 | 85 |
| 3 | 2000 | 1900 | 2015 | 1940 |
| % Removal | 25 | 54 | 56 | 73 |
| 4 | 1000 | 1000 | 975 | 975 |
| % Removal | 40 | 99 | 68 | 80 |
| 5 | 100 | 82 | 86 | 85 |
| % Removal | 83 | 89 | 96 | 91 |

### Example 2

### Heavy Metal Contaminant Removal from Groundwater

Through the following studies, the bio-based sorbent demonstrated capability for sieving lead (Pb²⁺), silver (Ag⁺), and cadmium (Cd²⁺) ions present in ground and surface water. By performing batch adsorption studies, the sorbent efficacy with respect to adsorbate dose, contact time, and the solution pH was evaluated while deducing the absorption isotherms and adsorption kinetics of the sorbent, revealing the sorbent's mechanistic pathway of heavy metal removal.

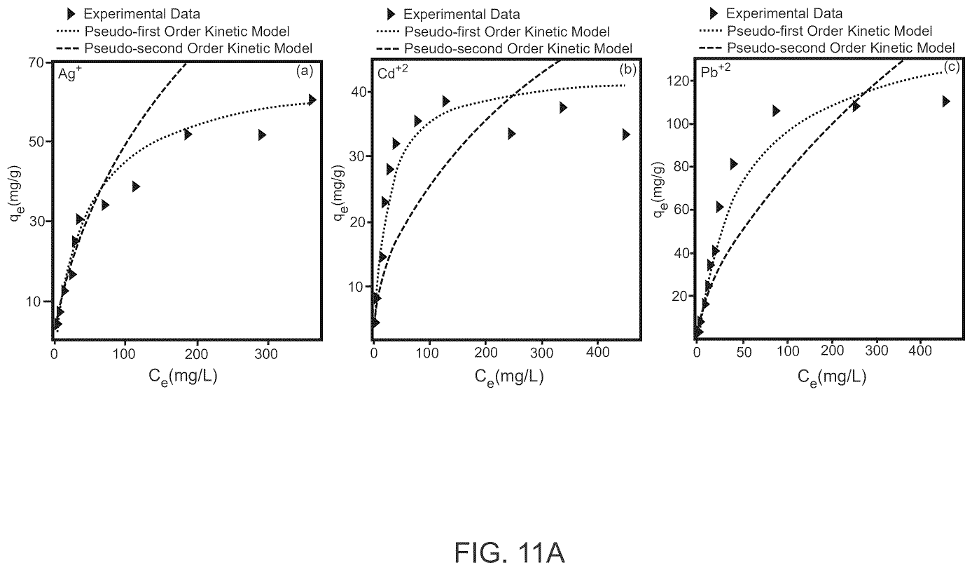

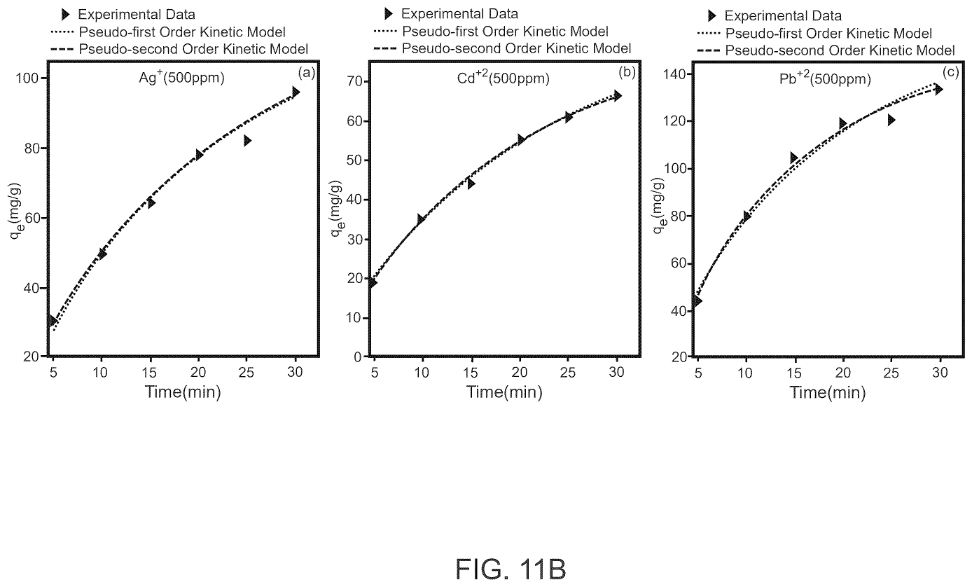

As indicated in the graphs of FIG. 11A, the comprehensive analysis, conducted for understanding the effect of each contaminant concentration on the sorbent's adsorption capacity, revealed an upward trend in all three metal ions adsorption with respect to their concentration, confirming high removal of heavy metal ions. The maximum adsorption capacity for silver (Ag⁺), cadmium (Cd⁺²) and lead (Pb⁺²) ions were 60.70, 38.62, and 110.84 mg/g within a 15 min of contact time, suggesting that the adsorbent has a sufficient surface area and active sites to effectively adsorb heavy metal ions at these concentrations. However, as the initial concentration further increased, the adsorption capacity exhibited a gradual increase, suggesting that at higher concentrations more heavy metal ions are available for adsorption onto the active sites of the sorbent. Further, higher maximum adsorption capacities at the saturation concentration of heavy metal ions suggested enhanced performance in lead, compared to silver and cadmium.

The time dependent (5 min to 30 min time intervals) adsorption studies confirmed that contact time for maximum adsorption saturation is 30 min, with gradual increases in the maximum adsorption capacity for each metal ion. As shown in the graphs of FIG. 11B, the adsorption capacity for silver is increased from initial adsorption capacity of 29.87 mg/g at 5 min to 96.25 mg/g at 30 min, whereas the adsorption capacity of cadmium increased from 18.74 mg/g to 66.54 mg/g at 30 min. Also, the adsorption capacity for lead increased from 43.98 mg/g at 5 min to 133.83 mg/g at 30 min.

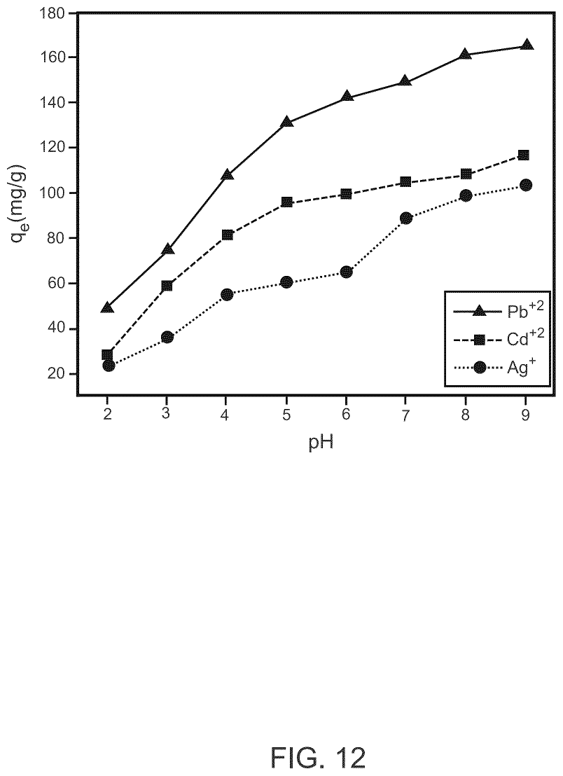

The solution pH study revealed that the removal of heavy metal ions from the solution was more favorable at higher pH values due to the negatively charged surface of the sorbent, resulting from increased deprotonation of the hydroxyl groups. The graph in FIG. 12 illustrates the influence of solution pH on the adsorption capacity of the sorbent (qₑ) for each heavy metal ion. As pH increased, the adsorption capacity of the adsorbent increased from 27.56 to 116.57 mg/g for Ag⁺, 23.06 to 104.04 mg/g for Cd²⁺, and 48.47 to 165.66 mg/g for Pb²⁺, respectively.

Based on these findings, the adsorption process relies on the adsorbent-adsorbate interactions between Ag⁺, Cd²⁺, and Pb²⁺ metal ions and the charged functional groups on the surface of the sorbent. At low solution pH, there is a competition between H+ ions and the positively charged heavy metal ions on the protonated surface of the adsorbent, leading to a decrease in the adsorption capacity. As the solution pH increases, the surface deprotonation of the sorbent takes place, resulting in negatively charged surface increasing the active sites for the adsorption, facilitating high adsorption of heavy metals onto the adsorbent.

### Example 3

### Pathogen Removal from Seawater/Groundwater

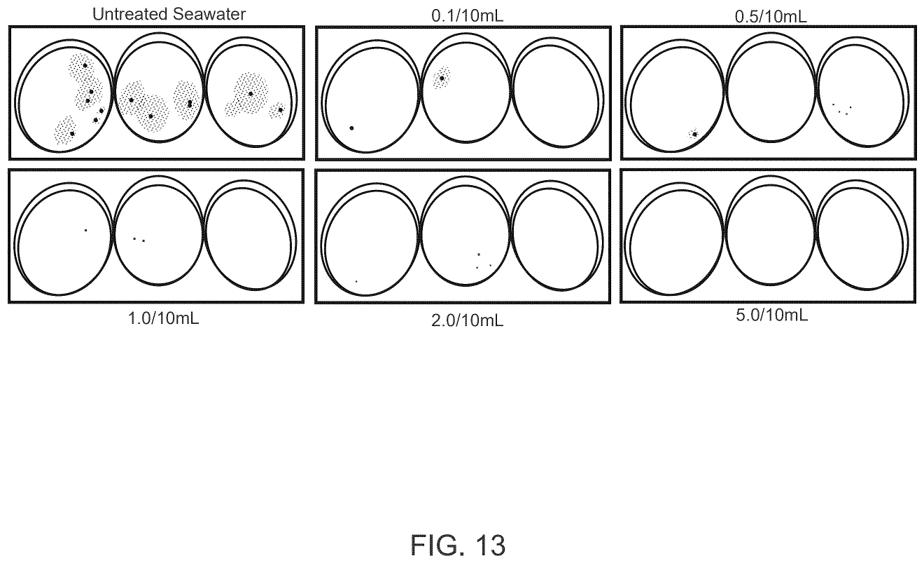

The sorbent's ability of removing pathogens from seawater was studied with respect to the different dose of sorbents. The water samples were treated with the sorbents at contact time of 15 min and a drop of eluent was casted on an agar plate and incubated at 36 Celsius for 96 hours. As depicted in FIG. 13, the water samples treated with different doses of sorbents showed minimal growth of pathogens compared to the untreated sample, supporting the sorbent's antimicrobial properties and its use for removing pathogens from water resources.

### Example 4

### Adsorption Study for 24 Hours

Adsorption desalination (AD) studies were conducted using synthetic brine samples, and seawater samples, employing a fixed-bed column set up at ambient conditions. The salinities of brine samples are in the same range as the salinity of brackish water. Herein, we used seawater as our upper salinity level for the sorbent's utility in adsorption desalination. The AD efficiency of the pristine sorbents for alkali (Na⁺ and K⁺), and alkaline (Mg²⁺, and Ca²⁺) cations were investigated using synthetic brine samples, with the concentration ranging from 100 ppm to 500 ppm, and the contact time of 24 hrs. The AD efficiency with respect to the initial concentration of each analyte in brine samples and the total salinity removal efficiency are depicted in FIGS. 17A and 17B, respectively. The Table 3 summarizes the AD efficiency of each cation along with the salinity removal efficiencies.

The pristine sorbents exhibit higher AD efficiency (>70%) for Ca²⁺ and Mg²⁺ cations with less than 8% efficiency reduction at 500 ppm brine concentration. However, sorbent's AD efficiency for Na⁺ and K⁺ shows almost half-fold reduction from the initial efficiency of ~53% to 30% for K⁺ and 49% to 25% for Na⁺, respectively, suggesting sorbents high efficacy for remediating the hardness of brackish water with moderate efficacy for cleansing alkali cations (Na⁺ and K⁺). The plots of individual cation's AD efficiency with respect to the brine concentration (FIG. 17A) suggest that AD efficiency of the pristine sorbents for Ca²⁺ and Mg²⁺ gradually decreases with the increase in concentration without reaching to desalination equilibrium for the selected brine concentration range (FIG. 17A). However, the AD efficiencies of Na⁺ and K⁺ gradually decrease with the increase of the brine concentration, and eventually reaching to a desalination equilibrium at 400 ppm, maintaining the AD efficiencies at 25% and 29% (FIG. 17A). The results convey that adsorption sites of the sorbents for Na⁺ and K⁺ ions at higher concentration reaches to partial saturation while removing hardness of brine continually exceeding 65% in high concentration brine. The total salinity removal efficiency of pristine sorbents decreases with respect to different salinity concentrations and reaches to desalination equilibrium with salinity removal efficiency of 20% at 4000 ppm, suggesting that sorbents could practically utilize for the desalination of brine with widely varying concentrations.

The adsorption characteristics of the sorbent for each competing analyte in brine solutions were also evaluated by obtaining the adsorption isotherms for each analyte with contact time of 24 hrs and are depicted in FIG. 17C-17F. The isotherms exhibit steady increase in equilibrium adsorption capacities (qₑ) with respect to equilibrium concentrations (Cₑ) and eventually reaching to adsorption equilibrium, yielding maximum average adsorption capacities of 729 mg/g, 646 mg/g, 292 mg/g, and 253 mg/g for Ca²⁺, Mg²⁺, K⁺, and Na⁺, respectively (Table 3). The isotherms of all four cations follow the Langmuir and Freundlich isotherm models,^{37,38} implying the monolayer and multilayer surface adsorption, eventually reaching to the saturation of sorbent's surface-active sites. The adsorption isotherm parameters calculated for Langmuir and Freundlich isotherm models (Eq (1)-(4)) are summarized in Table 3. The Langmuir maximum adsorption capacities calculated for Ca²⁺ and Mg²⁺ are significantly high, further convincing the sorbent's suitability for removing the hardness of brackish water and brines. Agreeing with the Freundlich isotherm model, Fe (III)-TA exhibits multilayer adsorption for all cations, but rather higher surface adsorption affinity for Ca²⁺ and Mg²⁺ ions, promoting the heterogeneous adsorption.

TABLE 3
Summary of adsorption characteristics, salinity removal efficiency, and adsorption
isotherms of pristine Fe(III)-TA sorbents for desalination of brine and seawater samples.

| Brine | | | | | Salinity Removal Efficiency (%) | |
|---|---|---|---|---|---|---|
| Concentration | Adsorption Efficiency (%) ± SD | | | | Initial salinity | AD Efficiency |
| (ppm) | Ca | Mg | K | Na | (ppm) | (%) |
| 100 | 77.92 ± 1.68 | 75.86 ± 1.64 | 52.71 ± 2.30 | 49.18 ± 2.11 | 618 | 36.90 ± 1.49 |
| 200 | 74.55 ± 2.05 | 78.13 ± 1.12 | 45.80 ± 2.02 | 37.93 ± 2.34 | 1236 | 29.70 ± 0.64 |
| 300 | 75.56 ± 1.24 | 74.97 ± 1.24 | 31.54 ± 1.18 | 30.45 ± 1.32 | 2737 | 21.10 ± 2.15 |
| 400 | 73.72 ± 0.65 | 71.79 ± 0.90 | 33.49 ± 1.34 | 25.89 ± 1.39 | 3572 | 24.70 ± 0.33 |
| 500 | 70.21 ± 1.16 | 65.90 ± 1.20 | 29.59 ± 1.44 | 25.08 ± 1.27 | 4387 | 20.70 ± 1.83 |
| qₘ (mg/g) | 729.07 ± 12.08 | 645.96 ± 11.75 | 292.48 ± 14.19 | 252.80 ± 12.80 | | |

Adsorption Desalination Isotherm Parameters

| Isotherm Model | Parameters | Ca | Mg | K | Na |
|---|---|---|---|---|---|
| Langmuir | q_{m (cal)} (mg/g) | 2245.09 | 1412.19 | 342.44 | 291.45 |
| Isotherm | K_{L} (L/g) | 0.003 | 0.006 | 0.009 | 0.01 |
| | R² | 0.99 | 0.97 | 0.88 | 0.97 |
| Freundlich | K^{f} (L/g) | 11.59 | 16.39 | 15.05 | 18.99 |
| Isotherm | n | 1.20 | 1.33 | 2.00 | 2.32 |
| | R² | 0.99 | 0.95 | 0.90 | 0.99 |

*Sorbents amount = 5 g; Sample feed volume = 20 mL; Seawater samples from Hatteras Beach, NC; Contact time 24 hrs

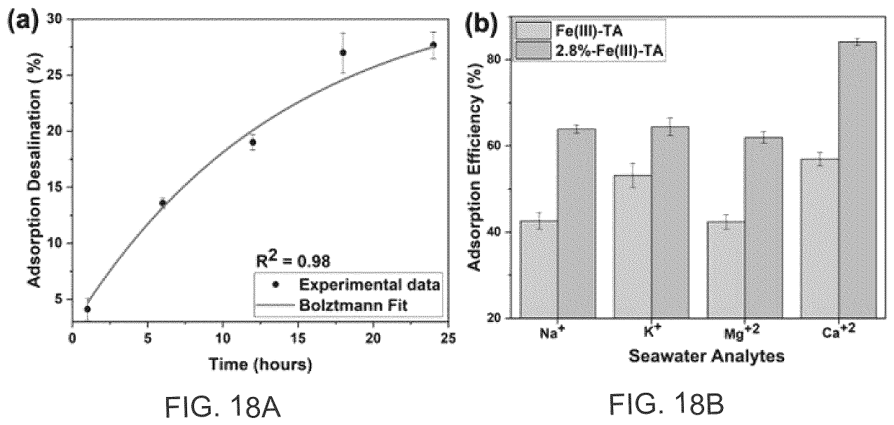

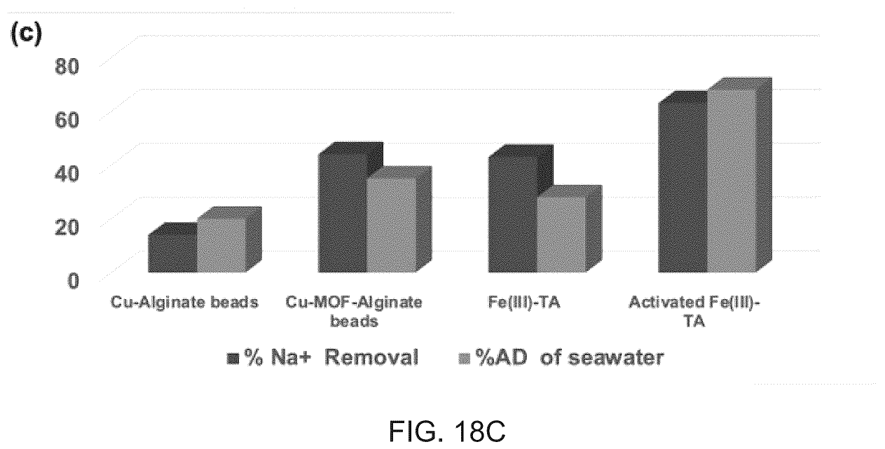

Batch adsorption desalination studies on the field collected seawater samples were also conducted using pristine sorbents and activated sorbents with 2.8% NH₄OH. The adsorption desalination efficiency of the pristine sorbent with respect to different contact time was first evaluated and are depicted in FIG. 18A The pristine sorbents exhibit gradual increase in adsorption efficiency with time and reach to adsorption desalination equilibrium at 24 hrs. As summarized in Table 4, The adsorption desalination efficiency of the pristine sorbents for the seawater with average salinity of 6315 ppm was found to be ~28% at 24 hrs and is slightly higher than the salinity removal efficiency of brine with concentration of 4000 ppm. Following the comparison plot of AD efficiency of pristine sorbent and activated sorbent for seawater desalination (FIG. 18B), the pristine sorbents show lower adsorption efficiencies for alkali and alkaline cations whereas activated sorbents have improved the AD efficiencies, with almost 20% increase in the efficiency. The activated sorbents exhibit the highest adsorption (84%) for Ca²⁺ and all other cations adsorb with the adsorption efficiency in the range of 61% to 63%. The amphoteric nature of the sorbent attributes to the improved adsorption efficiency upon activation of the sorbent with 2.8% NH₄OH, increasing negatively charge active sites on the sorbent's surface by deprotonating residual hydroxyl groups within catechol units of the tannic acid.³² As we described in our recent published work, this tailored activation process of switching the surface charges from neutral to negatively charged surface, allows us improving the adsorption affinity for cations over anions, yielding high removal efficiency of alkali and alkaline cations, thereby resulting in higher AD efficiency overall compared to pristine sorbents.

Comparative analysis was also conducted to evaluate the potential utilization of our biobased sorbent over similar biobased metal organic frameworks derived sorbents for efficient removal of Nations and adsorption desalination of seawater. Thus, we compared our sorbent's adsorption efficiency for Na⁺ ions and AD efficiency of seawater with Cu-Alginate beads and Cu-MOF-Alginate beads, which are the most structurally attributes sorbents for the comparison with Fe (III)-TA sorbents. As summarized in Table 4 and shown in FIG. 18C, in terms of Na⁺ removal and AD efficiency, our bio-based sorbents exhibit higher performance compared to the sorbents of Cu-Alginate or Cu-MOF-Alginate while offering significant performance in removing other alkali and alkaline cations with high adsorption capacity.

TABLE 4
Summary of AD efficiencies of analytes in seawater and comparison of Na⁺ removal and % AD
of seawater using pristine and activated Fe(III)-TA sorbents with prior reported bio-based sorbents.

| Adsorption efficiency of analytes in seawater (%) | | | | Previously reported sorbents | |
|---|---|---|---|---|---|
| | | Adsorption | Adsorption Efficiency | Adsorption | Adsorption |
| | | Efficiency by | by 2.8% NH₄OH | Efficiency by | Efficiency by |
| | Concentration | Pristine Fe(III)-TA | treated Fe(III)-TA | Cu-Alginate⁷⁵ | Cu-MOF-Alginate⁷⁵ |
| Analyte | (ppm) | (%) | (%) | (%) | (%) |
| Na | 5153.27 | 42.59 ± 1.92 | 63.90 ± 0.95 | 14 ± 1.0 | 44 ± 1.0 |
| Mg | 503.48 | 42.36 ± 1.72 | 61.97 ± 1.35 | — | — |
| K | 162.23 | 53.16 ± 2.83 | 64.45 ± 2.06 | — | — |
| Ca | 452.29 | 56.94 ± 1.58 | 84.12 ± 0.87 | — | — |

| | | | | |
|---|---|---|---|---|
| % AD of seawater | 27 ± 1.18 | 68.61 ± 1.30 | 20 ± 1.0 | 35 ± 5.0 |

### Prophetic Examples 5-7

Building on the current research and development success on the adsorption desalination from brines, such as those demonstrated in Examples 1~4 with salinity that ranged from 100 ppm to 27,000 ppm, the key objective of the following Prophetic Examples 5-7 is to tailor the adsorption parameters for different field collected brackish ground water samples, which are significantly low in salinity compared to brines. While tailoring the adsorption desalination parameters, including the sorbent's activation and the dose, flow rate, column dimension, and contact time, the structure-property relationship along with surface chemistry, interfacial interactions, colloidal stability in brackish water with different salinity and pH will be revealed. The anticipated outcomes will lay the foundation to understand sorbent's adsorption isotherms and adsorption mechanism for desalination in a complex heterogeneous environment.

The following three Prophetic Examples will be performed to test the statement that the “bio-based sorbent will exhibit an efficacy exceeding 90% in both adsorption desalination and the removal of pathogens and heavy metal contaminants from brackish groundwater.”

### Prophetic Example 5

### Studies on Various Brackish Groundwater Compositions

Brackish ground water in the USA is categorized into four main groups, with salinity and dominant ionic constituents as listed in Table 5. Experiments will be conducted on samples that follow the total dissolved salts concentrations with respective compositions as per Table 5.

TABLE 5
Characteristics of brackish groundwater in the USA.

| Mean dissolved salts (mg/L) | Composition |
|---|---|
| 1800 | NaHCO₃, SO₄²⁻ accounting |
| | for ⅓ of anion concentration |
| 2500 | CaSO₄, Na⁺, Mg²⁺ each accounting |
| | for ¼ of cation concentration |
| 1800 | NaCl |
| 8400 | Mixture of cations and anions with low |
| | solubility - high silica content |

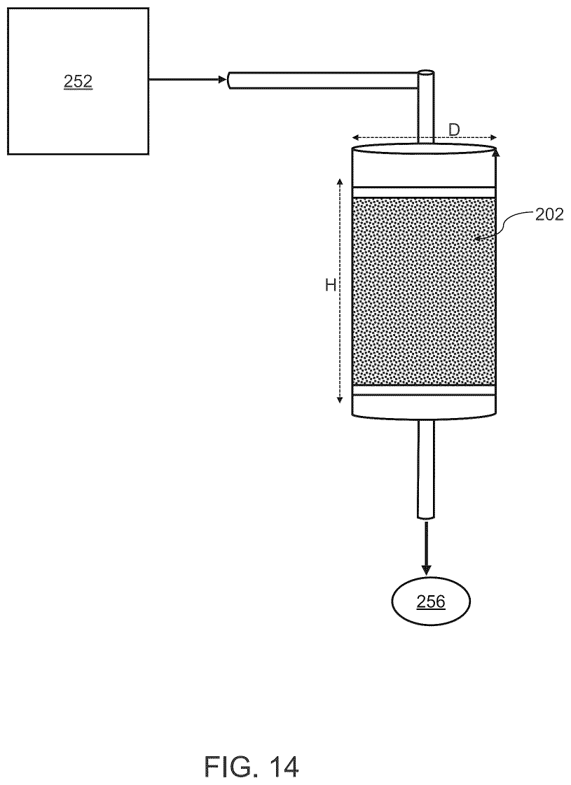

For our initial analysis, fixed-bed column set up will be employed using the same experimental conditions developed for brine analysis in Example 1 and reflected in Table 1. A schematic of the fixed bed glass column that will be utilized is shown in FIG. 14. The column will have a total length of 5 inches and an inner radius of 1 inch, packed with activated sorbents. The sorbents will be activated with either ammonium hydroxide or vinegar. The feed solution will be entered into column from top to bottom mode through peristaltic pump for maintaining desired flow rate. In the first set of analysis, the pump will be set to provide a flow rate of 20 mL/min, with an adsorbent dose of 10 g. The bed height and width will be tailored according to the flow rate adjustments, and analysis will be conducted in triplicate and average values will be considered for all the experiments. In a typical flow set up, the eluent collected from the first column with sorbents activated at pH>7 will feed in to the second column with sorbents activated at pH<4. At both columns, eluents will be analyzed using ICP-OES.

To evaluate the reusability of the sorbents, the sorption-desorption study will be carried out on a previously exhausted column (a column which has been utilized in an adsorption process) with a flow rate of 5 mL/min and initial TDS concentration of 8400 mg/L. The reason for selecting brackish water with the highest TDS concentration is to evaluate the sorbent efficacy with extreme brackish water conditions. Volumes of fluid with different weight % of vinegar and NH₄OH (1%, 2%, 2.5%, 3% and 5%) will be passed though the exhausted column at top-flow direction at flow rate of 5 mL/min. The amounts of TDS removed from column outlet will be determined. After the regeneration of the column, it will be soaked with distilled water (10 mL) for 24 hours and dried prior to the column conditioning with either vinegar or NH₄OH. Distilled water recovered from washing the columns will be purified by passing through a third column and will be reused in the desorption step, minimizing the freshwater usage. This adsorption-desorption process will be repeated at least up to 20 cycles and regeneration efficiency will be determined for each cycle using following equation, identified as Eq 1 below:

$$Regeneration efficiency ( \% ) = {q}_{t} / {q}_{i} \times 100 ; \qquad ( Eq 1 )$$

where, qₜ and qᵢ (mg/g) are adsorptive capacity of regenerated column and original capacity of the adsorbent, respectively.

From our initial experiments, if a desalination efficiency at least above 80% (both cations and anions) is met, the flow rate will be increased to 50 mL/min and the analysis will be conducted while maintaining sorbent dose, and column dimensions constant. The goal is to reach a flow rate of 100 mL/min with an adsorption desalination efficacy of 90%. Until the target is met, column parameters, sorbent dose, and sorbents' conditioning reagents will be adjusted. Through the above adjustments, the surface functionalization of the sorbents will be improved to enhance the active sites of the sorbent to remove a higher load of TDS.

### Prophetic Example 6

### Column Isotherm Model Selection and Study

In adsorption desalination, adsorption isotherms are a crucial component for analyzing the adsorption characteristics, which impact the desalination performance. Usually, for batch adsorption isotherms, most common isotherm models used are Langmuir, Freundlich and Temkin. However, column isotherms are usually explained by using Thomas, BDST and Adam & Bohart isotherm models. For our column isotherm studies, we will select optimal parameters, validated in Prophetic Example 5, for the flow rate of 100 mL/min. The maximum adsorption capacity will be calculated by fitting the data into Thomas model. If the correlation coefficient (R2) is >90th percentile, we will select Thomas model over other two model to analyze the adsorption characteristics allowing us to understand desalination behavior of our sorbent for brackish water treatment. When we apply the model, we will assume that there is no axial diffusion when the brackish water passed across the column bed.

### Prophetic Example 7

### Trace Metal Ion Removal and Disinfection Studies

Depending on the region brackish groundwater is collected, the trace metals present in water may vary. Most common trace metal ions are barium (Ba), strontium (Sr), aluminum (Al), and manganese (Mn). In some cases, the traces of heavy metals, such as lead, silver, cadmium, copper, and chromium could present in brackish water sources. In our current studies, an ability to remove heavy metals has been shown. Building on this work, the sorbent's adsorption efficacy for above trace metals, specially for most common ones, such as Ba, Sr, Al, and Mn, will be more comprehensively studied. These trace metals even at very low concentrations may precipitate and can lead to scaling during the treatment process.

After removing TDS from a volume of fluid passing through first two columns with negatively and positive charged sorbents, respectively, the eluent will transfer to the third column, which will be charged with non-activated sorbents. Maintaining the same flow rates as in Prophetic Example 5, eluent will be collected and analyzed for trace metals as well as for pathogens following the same approach already developed and discussed in Example 2 and Example 3. The only difference for these studies is a fixed bed column will be utilized instead of batch studies. The column parameters and sorbent dose, optimized in Prophetic Example 5 will be applied for the analyses.

### Prophetic Examples 8-9

The research approach for Prophetic Examples 8-9 concerns optimizing the technical baseline parameters, developed in Prophetic Examples 5-7, for the effluent feed capacity to meet a targeted metric by adjusting the column parameters, sorbents amount, and the flow rate. During these studies, the sorbents' stability, fouling and reusability will also be evaluated. The objective in Prophetic Examples 8-9 is to develop a dual-function sorbent-based remediation unit (DSRU), for adsorption desalination and disinfection process for treating brackish groundwater. Initially, the column parameters will be optimized to design solid-phase adsorption cartridges (SPACs) from the baseline technical performance parameters. Thereafter, a lab-scale test bed will be set up which treats water with the flow rate of 5 L/min. Additionally, a single system consisting of three cartridges for the treatment of brackish groundwater will be built. To build and test the lab-scale test bed, Prophetic Examples 8-9 will be conducted to serve as a technology baseline to bring the flow unit to a bench-scale continuous flow unit with feed rate of 100 L/min (26 gal/min) demonstrating the feasibility of research during earlier phases.

The following two Prophetic Examples will be performed to test that the solid-phase adsorption cartridges will successfully achieve an efficacy of over 90% for desalination and surpass 99% for the removal of pathogens and heavy metal contaminants.

### Prophetic Example 8

### Solid-Phase Adsorption Cartridge Design and Optimization

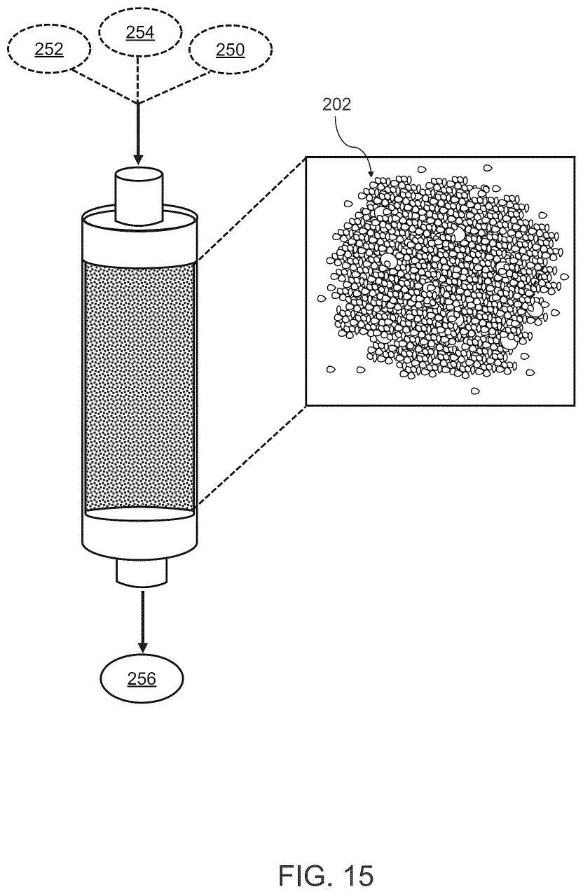

By adapting the column parameters developed in Prophetic Example 5, SPACs will be custom designed. As shown in FIG. 15, the design will include a heavy-duty PTFE column with PTFE sealing ring in the top end and PTFE plug in the bottom end followed by two filter frits (pore size 0.45 μm) to avoid leaching of adsorbents.

A series of experiments to further tailor the sorbent dose and cartridge's dimensions, while adjusting other parameters, like sorbent activation, pH of the feed and pressure of the feed, will be conducted for the optimization of analytical parameters to achieve the desalination efficiency of >90% and 99% efficiency for trace metal contaminants and pathogens removal.

The number of regeneration cycles that cartridges can be used will also be analyzed by performing continuous adsorption and desorption cycles at three different salinity levels (low, medium, and high). After each adsorption-desorption cycle, the column will be conditioned with conditioning reagents, such as ammonium hydroxide or vinegar. The entry flow rate and permeation flow rate will be measured at each cycle. Up to 20 cycles will be run at each of the salinity levels and then the number of cycles will increase until no adsorption desalination occurs. At each cycle, the eluent will be analyzed for TDS removal capacity, trace metal removal capacity and disinfection efficacy.

In a second set of experiments, the fouling of the cartridges after we reach to our maximum number of regenerative cycles will be analyzed. With the current findings, as these sorbents exhibit antimicrobial properties, minimal fouling is expected of our cartridges after maximum use.

### Prophetic Example 9

### DSRU with Continuous Flow Process Design and Optimization

The SPACs, which met initial success metrics in Prophetic Example 8 for 5 L/min flow rate at the optimized entry pressure will connect in series up to three cartridges (for removing cations, anions, and trace metal and pathogens) to build the DSRU. The assembled view of the DSRU is depicted in FIG. 16, augmenting a three-stage backwashing filter design. For the initial studies, one flow unit will be assembled and connected to the brackish groundwater reservoir (25 gal), which will be connected to a flow rate and pressure-controlled system. The performance of the unit will be evaluated for the flow rate, internal pressure (starting from 0.02 psi), chemical stability towards different salinity levels, and clogging, by running one unit at least a week prior to evaluating its efficiency. During the initial studies, revisiting Prophetic Example 5 and Prophetic Example 8, the cartridge's dimensions, sorbent bed height, and conditioning parameters will be optimized to address the initial technical problems encountered with the unit design. The sorption capacity of the unit performing the same experiments as in Prophetic Example 8 will be evaluated first with synthetic solutions and then with field collected brackish water samples, having different salinity levels. Optimization of the flow process will be conducted to achieve the targeted metrics of the flow process for 5 L/min to yield desalination and tertiary treatment efficiency of >90%.

### Prophetic Examples 10-11

To understand the effect of treated brackish water produced by an embodiment of the method/system herein on the soil health and plant growth, Prophetic Examples 10 and 11 will be conducted by setting up a controlled test-bed environment for corn plants and the growth will be monitored over the period of four months. The testbed will consist with six blocks (three replicates for control and experiment, respectively) each with dimensions of 2×2×4 ft (length, width, and height). All six blocks will be maintained at same conditions with the exception that the controls will use fresh water and the experiments will use brackish groundwater, purified using an embodiment of the system/method provided herein. Approximately 2″ healthy corn plants will be used for this study. Corn was selected as the test subject because it is one of the most important crops in the US. The soil moisture, soil salinity, and plant growth will be monitored over the specified period.

### Prophetic Example 10

### Brackish Groundwater Treated Soil Physiochemical Property Study

In this example, soil sampling and analysis will be conducted at each stage of the planting process of corn plants. Data for soil moisture content and soil salinity will be collected by taking three measurements for each treatment. The soil moisture content will be measured using a handheld soil moisture sensor meter (XLUX T10 Soil Moisture Sensor Meter). The volumetric soil water content in each plot will be measured at depths of 0-20 cm, 20-40 cm, 40-60 cm, 60-80 cm, and 80-100 cm. To measure soil salinity, soil samples will be taken from same depths as above on the same days. For soil salinity analysis, in a typical procedure, the soil samples will be soaked in deionized water over 24 hours and the filtrate will be collected. Using a TDS meter, the TDS level of each filtrate will be measured. The data collected for controls will be compared with the experimental data to evaluate the impact of treated brackish groundwater. It is anticipated that there will be no significant variation in soil treated with brackish ground water and freshwater, respectively.

### Prophetic Example 11

### Corn Plant Physiological Growth Study

Leaf area index (LAI) and plant height will be taken as key indices to understand the effect of brackish water on the physiological growth of corn plants. The data will be collected four times during the growing season of days after planting at 35-42 days (Vegetative stage 1), 57-64 days (Vegetative stage 2), 75-79 days (Flowering stage), and 90-101 days (Yield stage). During the harvesting time, the length of corn ears will be measured and compared with the controls. From the data analysis, it is anticipated that there will be no significant difference in LAI, plant height, and corn ear's length for the plants treated with remediated brackish groundwater compared to the plants treated with freshwater.

What is claimed is:

1. An adsorptive desalination and disinfection method for saltwater utilizing a polymer impregnated amphoteric sorbent, the method comprising:
providing a volume of saltwater to be desalinated and disinfected;
passing the volume through a first filter cartridge assembly configured to disinfect and remove cations from the volume passed therethrough, wherein the first filter cartridge assembly comprises an anionic sorbent comprising the polymer impregnated iron (III)-tannate amphoteric sorbent configured to exhibit anionic behavior; and
passing the volume through a second filter cartridge assembly configured to disinfect and remove anions from the volume passed therethrough, wherein the second filter cartridge assembly comprises a cationic sorbent comprising the polymer impregnated iron (III)-tannate amphoteric sorbent configured to exhibit cationic behavior, wherein the volume passed through the first filter cartridge assembly and second filter cartridge assembly is at least partially desalinated and disinfected.

2. The adsorptive desalination and disinfection method for saltwater of claim 1, wherein providing the volume of saltwater comprises:
settling an input in at least one of a basin and a clarifier to produce the volume, wherein the input comprises saltwater and particulate and the basin and clarifier are each configured to remove particulate from the input.

3. The adsorptive desalination and disinfection method for saltwater of claim 2, wherein providing the volume of saltwater comprises:
filtering the input through a particulate filter to further remove particulate therefrom and produce the volume, wherein the particulate filter is configured to remove particulate from the input.

4. The adsorptive desalination and disinfection method for saltwater of claim 1, wherein providing the volume comprises:
filtering an input through a particulate filter to further remove particulate therefrom and produce the volume, wherein the input comprises saltwater and particulate and wherein the particulate filter is configured to remove particulate from the input.

5. The adsorptive desalination and disinfection method for saltwater of claim 1, further comprising passing the volume through a third filter cartridge assembly after passing the volume through the first filter cartridge assembly and second filter cartridge assembly, wherein the third filter cartridge assembly is configured to remove trace metal ions and further disinfect the volume such that the volume exiting the third filter cartridge assembly comprises desalinated and disinfected water.

6. The adsorptive desalination and disinfection method for saltwater of claim 1, further comprising conditioning the polymer impregnated iron (III)-tannate amphoteric sorbent with ethylene glycol to produce the anionic sorbent.

7. The adsorptive desalination and disinfection method for salt water of claim 6, wherein conditioning the polymer impregnated iron (III)-tannate amphoteric sorbent with ethylene glycol to produce the anionic sorbent comprises exposing the polymer impregnated iron (III)-tannate amphoteric sorbent to an environment having a pH above 7.0.

8. The adsorptive desalination and disinfection method for salt water of claim 7, wherein conditioning the polymer impregnated iron (III)-tannate amphoteric sorbent with ethylene glycol to produce the anionic sorbent further comprises soaking the polymer impregnated iron (III)-tannate amphoteric sorbent in a 1:1 w/v ratio of the polymer impregnated iron (III)-tannate amphoteric sorbent to ethylene glycol.

9. The adsorptive desalination and disinfection method for saltwater of claim 8, wherein conditioning the polymer impregnated iron (III)-tannate amphoteric sorbent with ethylene glycol to produce the anionic sorbent further comprises soaking the polymer impregnated iron (III)-tannate amphoteric sorbent for 24 hours and air drying the polymer impregnated iron (III)-tannate amphoteric sorbent at ambient conditions for a plurality of hours.

10. The adsorptive desalination and disinfection method for saltwater of claim 1, further comprising conditioning the polymer impregnated iron (III)-tannate amphoteric sorbent with vinegar to produce the cationic sorbent.

11. The adsorptive desalination and disinfection method for saltwater of claim 10, wherein conditioning the polymer impregnated iron (III)-tannate amphoteric sorbent with vinegar to produce the cationic sorbent comprises exposing the polymer impregnated iron (III)-tannate amphoteric sorbent to an environment having a pH below 3.5.

12. The adsorptive desalination and disinfection method for saltwater of claim 11, wherein conditioning the polymer impregnated iron (III)-tannate amphoteric sorbent with vinegar to produce the cationic sorbent comprises soaking the polymer impregnated iron (III)-tannate amphoteric sorbent in a 1:1 w/v ratio of the polymer impregnated iron (III)-tannate amphoteric sorbent to vinegar.

13. The adsorptive desalination and disinfection method for saltwater of claim 12, wherein conditioning the polymer impregnated iron (III)-tannate amphoteric sorbent with vinegar to produce the cationic sorbent comprises soaking the polymer impregnated iron (III)-tannate amphoteric sorbent for 24 hours and air drying the polymer impregnated iron (III)-tannate amphoteric at ambient conditions for a plurality of hours.

14. The adsorptive desalination and disinfection method for saltwater of claim 1, further comprising regenerating at least one of the anionic sorbent and cationic sorbent through soaking a respective sorbent in a first solution for 24 hours, wherein the first solution comprises 1:1 w/v ratio of the respective amphoteric sorbent to vinegar, washing the respective amphoteric sorbent in a second solution, wherein the second solution comprises 1:1 w/v ratio of the respective amphoteric sorbent to water, and air drying the respective amphoteric sorbent thereof at ambient conditions.

15. The adsorptive desalination and disinfection method for saltwater of claim 1, wherein the first filter cartridge assembly and the second filter cartridge assembly each comprise a filter housing enclosing a removable filter cartridge comprising a respective amphoteric sorbent therein.

16. The adsorptive desalination and disinfection method for saltwater of claim 15, wherein the filter housing comprises a central cover disposed between an inlet end cap and a retentate end cap, wherein the filter cartridge is disposed within the central cover between the inlet end cap and the retentate end cap and is in fluid communication with fluid moving from the inlet end cap to the retentate end cap, and wherein at least one of the inlet end cap and retentate end cap are removable from the central cover or the central cover is configured to open to allow the filter cartridge to be removed.

17. The adsorptive desalination and disinfection method for saltwater of claim 1, wherein the cations removed comprise at least one of sodium atom cations, potassium atom cations, magnesium atom cations, silver atom cations, cadmium atom cations, lead atom cations and calcium atom cations.

18. The adsorptive desalination and disinfection method for saltwater of claim 1, further comprising providing the polymer impregnated amphoteric sorbent by:
forming a combined solution comprising an iron (III)-tannate powder and a polysulfone polymer solution, wherein the polysulfone polymer solution comprises a mixture of polysulfone and 1-methyl-2-pyrrolidone (NMP),
pumping the combined solution into a volume of water to precipitate the polymer impregnated iron (III)-tannate amphoteric sorbent,
removing the polymer impregnated iron (III)-tannate amphoteric sorbent from the volume of water, and
drying the polymer impregnated iron (III)-tannate amphoteric sorbent.
